(19) United States
(12) Patent Application Publication
(10) Pub. No.: US 2011/0196795 A1
(43) Pub. Date: Aug. 11, 2011

(54) FINANCIAL, ACCOUNT AND LEDGER WEB APPLICATION AND METHOD FOR USE ON PERSONAL COMPUTERS AND INTERNET CAPABLE MOBILE DEVICES

(76) Inventor: Ivan Andrew POINTER, Salem, OR (US)

(21) Appl. No.: 13/021,732

(22) Filed: Feb. 5, 2011

Related U.S. Application Data
(60) Provisional application No. 61/302,035, filed on Feb. 5, 2010.
(60) Provisional application No. 61/349,511, filed on May 28, 2010.

(51) Int. Cl. G06F 21/00; G06Q 10/00

(52) U.S. Cl. 705/51; 705/30

(57) ABSTRACT

The method and web application is for users of cellular mobile devices to keep track of their personal finances while the user is mobile. The web application is accessed via internet capable mobile devices to record financial transactions such as debit, credit, and cash transactions at the point of the transaction, to avoid lost or forgotten transactions and avoid bank overdraft charges. The method and web application will provide five sets of tools as a service to customers. These sets are: Account ledger, account balancing tools, bill and debt management, budgeting tools, and user management tools.

The current application is a nonprovisional application and claims a priority to the U.S. provisional patent application Ser. No. 61/302,035 filed on Feb. 5, 2010 and Ser. No. 61/349,511 filed May 28, 2010.

### FIELD OF INVENTION

This invention relates to the method and web application for users of internet capable mobile devices as a method of keeping track of their personal finances while the user is mobile. The web application will be accessed via any internet capable mobile device, to record financial transactions such as debit, credit and cash transactions, at the point of the transaction, to avoid lost or forgotten transactions, to keep an accurate running balance, and to avoid bank overdraft charges. Some examples of use would be while using their debit card for a transaction at a grocery store, ATM, or any check-out counter where purchases are made.

### BACKGROUND OF THE INVENTION

With the advance of mobile communication technology, the web application for managing financial, account and ledger information has been more desirable via a web browser or web services on a personal computer or internet capable mobile device such as cellular phone, smart phone, PDA device and iPhone etc. . . . .

A mobile device typically includes both hardware and software. The software may be stored on a computer-readable medium in the form of computer-readable instructions. A mobile device may read those computer-readable instructions, and in response perform various steps as defined by those computer-readable instructions. Thus, any functions attributed to a mobile device as described herein may be defined by such computer-readable instructions read and executed by that mobile device, and/or by any hardware (e.g., a processor) from which the mobile device is composed. The term “computer-readable medium” as used herein includes not only a single medium or single type of medium, but also a combination of one or more media and/or types of media. Such a computer-readable medium may store computer-readable instructions (e.g., software) and/or computer-readable data (IE., information that may or may not be executable).

There are commercially available web accessed financial applications with very limited functions on account access and updating. These applications are usually tied with financial institutions, banks or merchant directly with only limited options to access. The commercially available web accessed financial applications store transaction data on the client device, as opposed to having the data stored on a server. Highly integrated and self trainable sets of tools as a service to customers which provide basic financial, account, and ledger web application to financial institutions are much in demand for the coming era.

### SUMMARY OF INVENTION

A method and web application for persons and entities for managing financial, account and ledger information to be accessed via a web browser or web services on a internet capable device or personal computer or internet capable mobile device. The method and web application will provide an array of services for managing financial accounts, finances and ledger information. The application will be secure, behind SSL encryption and hosted on a server to be accessed by any device which is internet capable. Users of the application may or may not be charged for the services.

The invention presents a method of financial, account and ledger web application on a system comprising:
a plurality of internet or network capable mobile devices or computers;
a server with a database which contains user account, web application account, user role, financial, and transactional data;
a database interface configured to access the database; and
a network interface to access the server;
by executing computer-executable instructions stored on a non-transitory computer-readable medium, and
the method comprises a highly integrated tool set of:
   an account transactional ledger tool, comprising the steps of:
initiation by an initial balance during account setup;
automatically working with the automatically recurring payroll as configured by the end user; and
billing and budgeting to provide a more accurate available account balance;
an account balancing tool, comprising the steps of:
balancing user's books;
connecting to banking systems to retrieve a user's financial information;
capable to be trained to automatically clear transactions in the ledger when they are found in the bank's transaction information; and
if it is questionable whether there is a match between a given transaction in the bank and in the ledger, this will be brought to the user's attention in the tool via the application itself or SMS (text-message) or email;
a bill management tool, comprising the steps of:
setting up recurring bills and temporary or recurring payment schedules and debts;
automatically generating alerts, via email, text messages and in application notices to remind users to pay individual bills and debts;
creating an estimated recurring payroll into the account for the user; and
integrating with the account ledger functions to provide a more accurate available account balance by creating an entry in the ledger to represent a transaction that is and will be in the financial institution transactions from the ledger to pay automatically recurring bills and temporary payment schedules;
   a budgeting tool, comprising the steps of:
providing the ability to create a personal budget based on static amounts or percentages of their income;
creating budgets or budgetary accounts as virtual accounts to better segregate money; and
automatically creating a transaction within the ledger to represent the flow of money from the main account into the virtual account based on a user created schedule;
a user management tool, comprising the steps of:
allowing the administrator of the account to create additional users attached to their account; and
providing self help functions for resetting passwords and retrieving lost account information;
wherein the said web application is built with any programming language, software framework or software server;
wherein the said software framework is any set of program libraries or code which is intended for use within another program;
wherein the said server is available to any intranet, internet, GAN, WAN, LAN, or any other computer network; and
wherein the said web application is for the said mobile devices or the said computers to access the web application and persons or entities may or may not be charged for use of the said web application;
wherein said user account data comprises user id, password, first name, middle name, last name, suffix, prefix, billing address, physical address, birth date, password security question, password security answer and email address;
wherein said web application account data represents individual application accounts and comprises unique id, master user id, activation date, expiry date and account status;
wherein said user role data comprises account membership and account user role data;
wherein said account membership data comprises account unique id and user id and is used to associate users of the web application to the individual accounts;
wherein said financial data comprises financial account, debt, budget and payroll data; and
wherein said transactional information are transaction records for debts and credits wherein said transaction records contain transaction record id, user account id, financial account id, creating user id, modifying user id, transaction status, transaction date, transaction type, check number, transaction category, transaction description, transaction amount, transaction clearance status and running balance;
wherein all user interfaces in this application may be implemented with a template framework ready for internationalization;
wherein all user interfaces screens follow the standard display process; and
wherein all the user interfaces appear on the said mobile devices or computers or SMS or email;
wherein the said web application is secure, behind the Secure Sockets Layer (SSL) encryption and hosted on the said server to be accessed by the said mobile devices or computers and
wherein said password is a string, or a secure hash of a string, either given to, or selected by the user of the web application, and is used to authenticate the user of the web application.

### BRIEF DESCRIPTION OF THE DRAWINGS

FIG. 1 is the flow diagrams for request to login steps.

FIG. 2 is the flow diagrams for request to login steps.

FIG. 3 is the flow diagrams for request to logout steps.

FIG. 4 is the flow diagrams for request to password processing steps.

FIG. 5 is the flow diagrams for request to password processing steps.

FIG. 6 is the flow diagrams for request to password processing steps.

FIG. 7 is the flow diagrams for request to password processing steps.

FIG. 8 is the flow diagrams for request to payroll steps.

FIG. 9 is the flow diagrams for request to payroll steps.

FIG. 10 is the flow diagrams for request to payroll steps.

FIG. 11 is the flow diagrams for request to budgetary account steps.

FIG. 12 is the flow diagrams for request to budgetary account steps.

FIG. 13 is the flow diagrams for request to financial account steps.

FIG. 14 is the flow diagrams for request to financial account steps.

FIG. 15 is the flow diagrams for request to transaction steps.

FIG. 16 is the flow diagrams for request to transaction steps.

FIG. 17 is the flow diagrams for request to financial cassette steps.

FIG. 18 is the flow diagrams for request to financial cassette steps.

FIG. 19 is the flow diagrams for request to transaction steps.

FIG. 20 is the flow diagrams for request to transaction steps.

FIG. 21 is the flow diagrams for request to transaction steps.

FIG. 22 is the flow diagrams for request to subscription steps.

FIG. 23 is the flow diagrams for request to subscription steps.

FIG. 24 is the flow diagrams for request to retrieve lost user steps.

FIG. 25 is the flow diagrams for request to payment steps.

FIG. 26 is the flow diagrams for request to register steps.

FIG. 27 is the flow diagrams for request to register steps.

FIG. 28 is the flow diagrams for request to register steps.

FIG. 29 is the flow diagrams for request to debt steps.

FIG. 30 is the flow diagrams for request to debt steps.

FIG. 31 is the flow diagrams for request to debt steps.

FIG. 32 is the flow diagrams for request to calculating available balance steps.

FIG. 33 is a typical screen display for basic ledger.

FIG. 34 is a typical screen display for user password reset.

FIG. 35 is a typical screen display for user login.

FIG. 36 is a typical screen display for user password reset.

FIG. 37 is a typical screen display for user registration.

FIG. 38 is a typical screen display for select subscription.

FIG. 39 is the flow diagrams for request to register steps.

### DETAIL DESCRIPTIONS OF THE INVENTION

As used herein, a “mobile device” means a wireless portable two-way communication apparatus intended to be held in a user's hand during normal operation, e.g. a cellular telephone, personal digital assistant (PDA), etc. An exemplary mobile device can include a display screen, user input controls associated with cursor and screen control, and often a keypad and/or keyboard or a touch screen device—such as the iPhone for accepting additional user inputs. Any mobile device can be used with the embodiments described herein.

A mobile device typically includes both hardware and software. The software may be stored on a computer-readable medium in the form of computer-readable instructions. A mobile device may read those computer-readable instructions, and in response perform various steps as defined by those computer-readable instructions. Thus, any functions attributed to a mobile device as described herein may be defined by such computer-readable instructions read and executed by that mobile device, and/or by any hardware (e.g., a processor) from which the mobile device is composed. The term “computer-readable medium” as used herein includes not only a single medium or single type of medium, but also a combination of one or more media and/or types of media. Such a computer-readable medium is non-transitory and may store computer-readable instructions (e.g., software) and/or computer-readable data, i.e. information that may or may not be executable). The method of this invention may be performed by executing computer-executable instructions stored on the said non-transitory computer-readable medium.

Many systems keep users in what is known as an LDAP. This system allows for the users to be stored within the LDAP and the data is to be stored in a database. The users can be either in the database, or the LDAP. In many enterprises, many servers will have a plurality of network interfaces including both software and hardware, The DB, Application server, Web Server and LDAP server may all reside on different “servers”. There are two kinds of servers: software and hardware. A single hardware server can contain multiple software servers. It is beneficial to allow the different parts of the application to be on different servers which allow for load balancing, clustering and even cloud computing.

The method and web application will provide five sets of tools as a service to customers. These sets are: Account Ledger, Account Balancing Tools, Bill and Debt Management, Budgeting Tools, and User and Account Management Tools. These sets of tools will work intimately together.

The Account Ledger is a transactional ledger, to be initiated by an initial balance during account setup or when the financial account is added to the user account. The account ledger will automatically work with the automatically recurring payroll, bills and budget to provide a more accurate available account balance.

The Account Balancing Tools comprises a set of tools for balancing user's books as well as connecting to banking systems to retrieve a user's financial information. The Account Balancing Tools will be able to be “trained” to automatically clear transactions in the ledger when they are found in the banks transaction information. If it is questionable whether there is a match between a given transaction in the bank and in the ledger, this will be brought to the user's attention in the tool. Also, if there are transactions found in the banks transaction information that is not found in any way in the ledger information, the user may be notified by SMS or email. In either case, the application requests that the user take action by either creating a new transaction in the ledger for the bank information, or by selecting a matching transaction in the ledger to clear. In either case the system automatically creates a rule for the relationship—further “training” the balancing tool.

The Bill Management tools will provide users of the web application the ability to set up recurring bills as well as recurring or temporary payment schedules and debts. The bill management toolset will automatically generate alerts, via email, text messages and in application notices to remind users to pay individual bills and debts. The tool will work with the account ledger to provide a more accurate available account balance by preemptively creating a transaction within the ledger for the recurring bills and temporary payment schedules. The ledger application does not actually perform transfer of monetary value, only the representation therein. The user can also create an estimated recurring payroll into the account which will automatically create a transaction in the ledger reflecting a preset amount being deposited based on a user configured schedule.

The Budgeting tools will provide the ability to create a personal budget based on static amounts or percentages of their income. Virtual accounts can be created to better segregate money. A transaction will be created each in the main account and the virtual account to represent money being moved from one to the other, e.g. a withdrawal in the “real” account and a deposit in the “virtual” account to move money from the “real” account to the “virtual” account.

The User Management tools will allow the administrator of the account to create additional users attached to their account. Self help tools will be provided for resetting passwords and retrieving lost account information.

The Budgeting tools create budgets or budgetary accounts as virtual accounts to better segregate money. The Budgeting tools create a transaction within the ledger to represent the flow of money from the “real” account into the virtual account. For balancing purposes, a “budgeting account” is attached to a single “real” account, and these transfer transactions are ignored by the budgeting tool—as they do not represent money actually entering or leaving the “real” account.

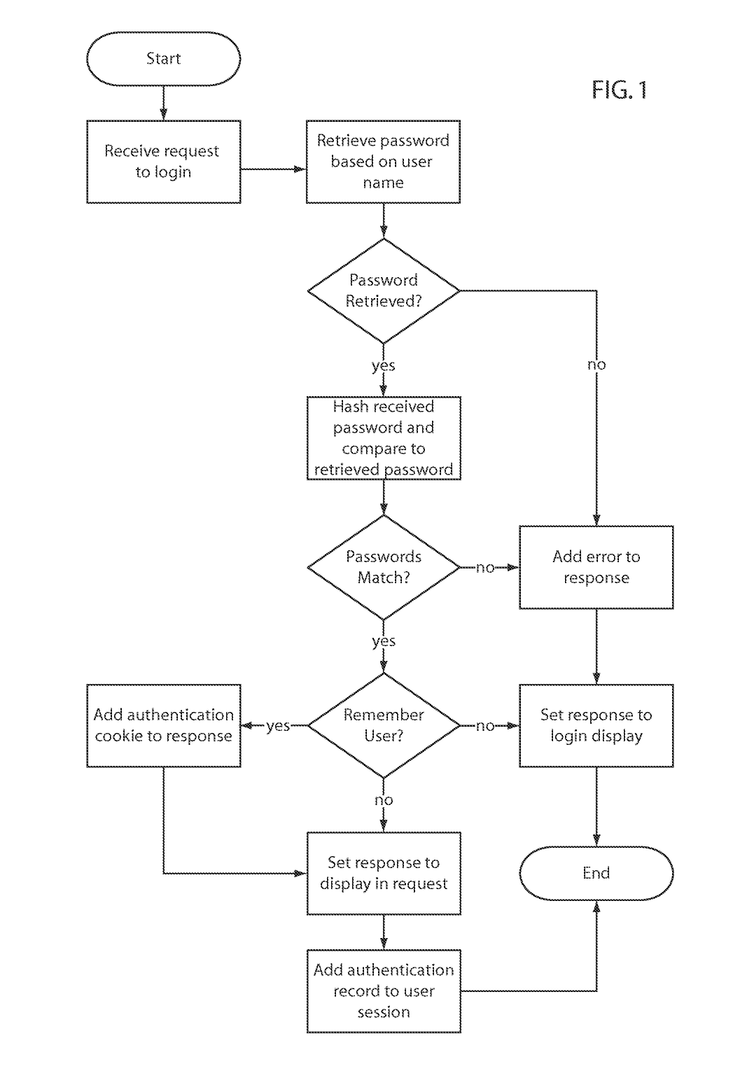

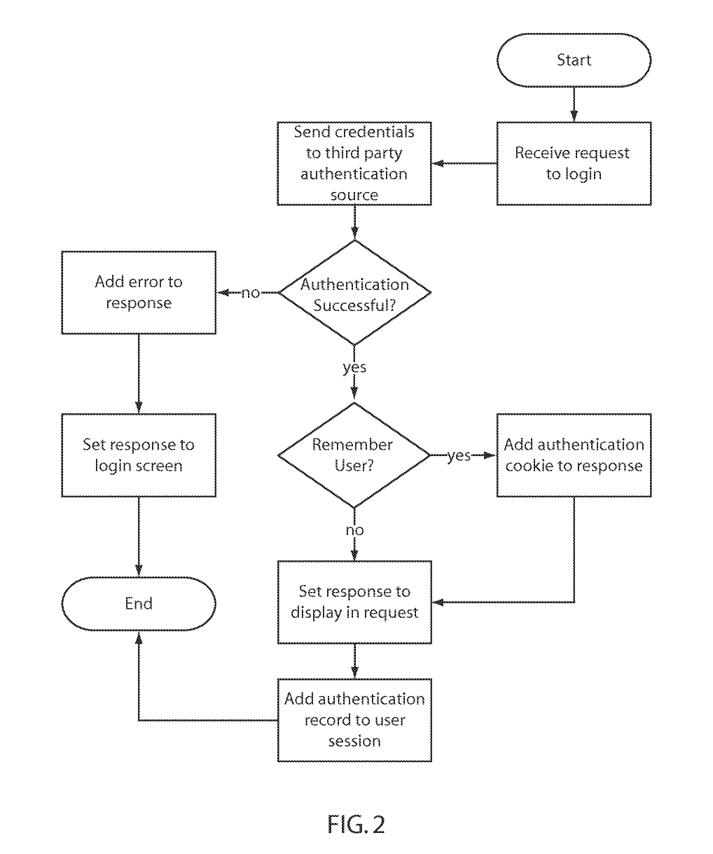

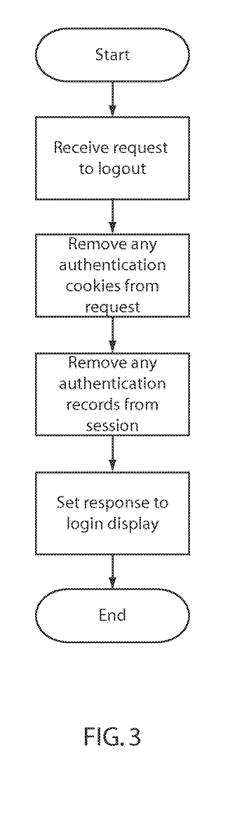

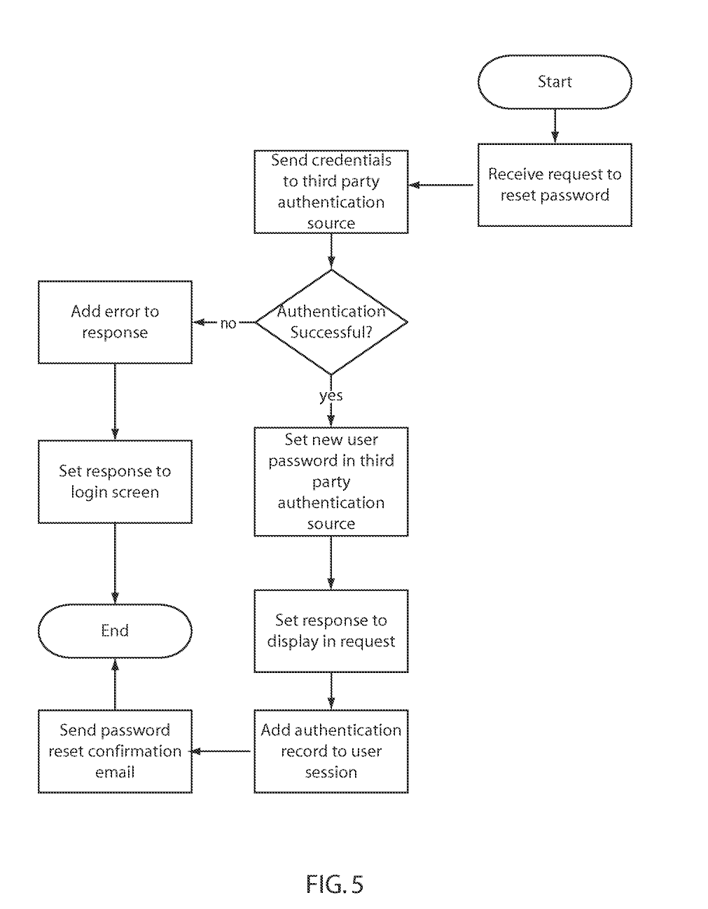

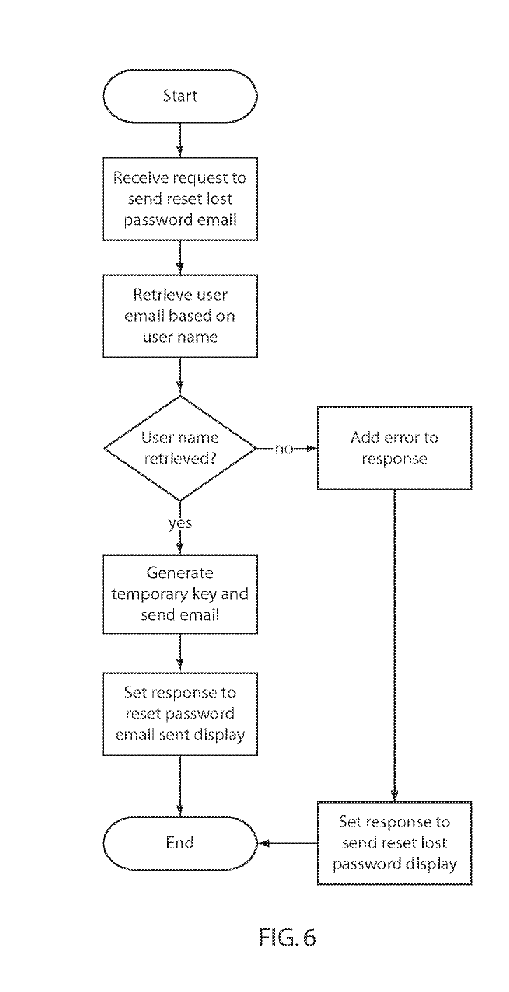

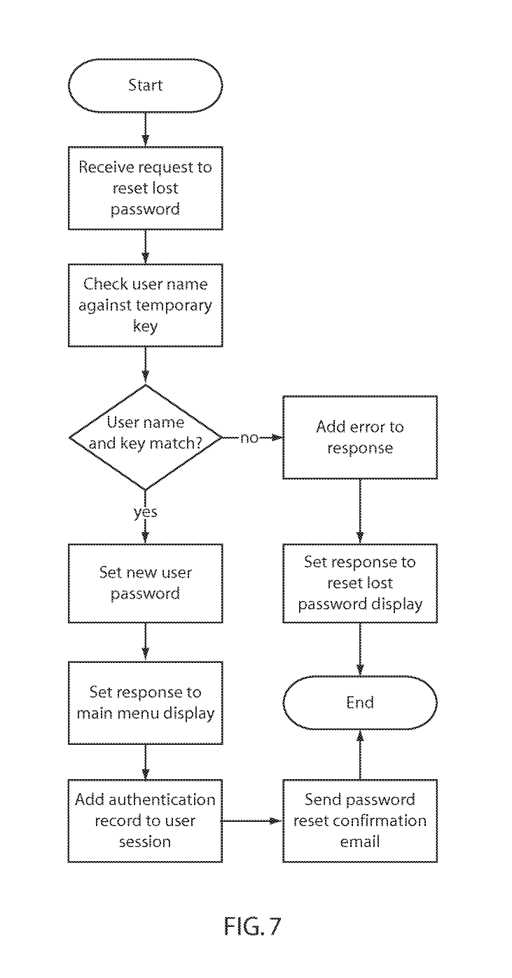

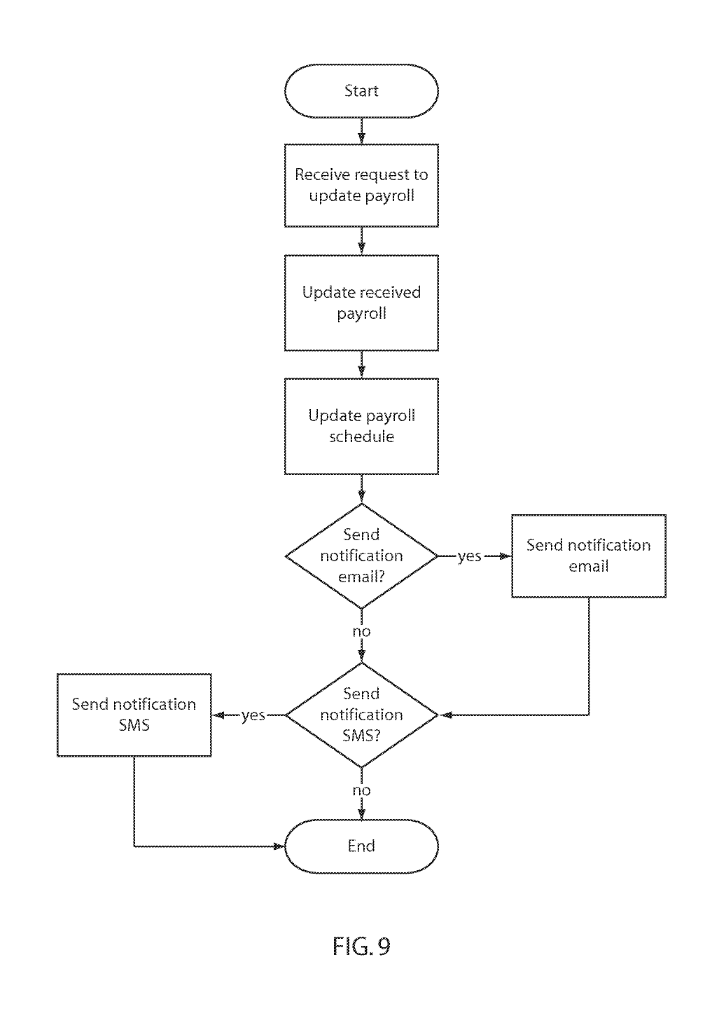

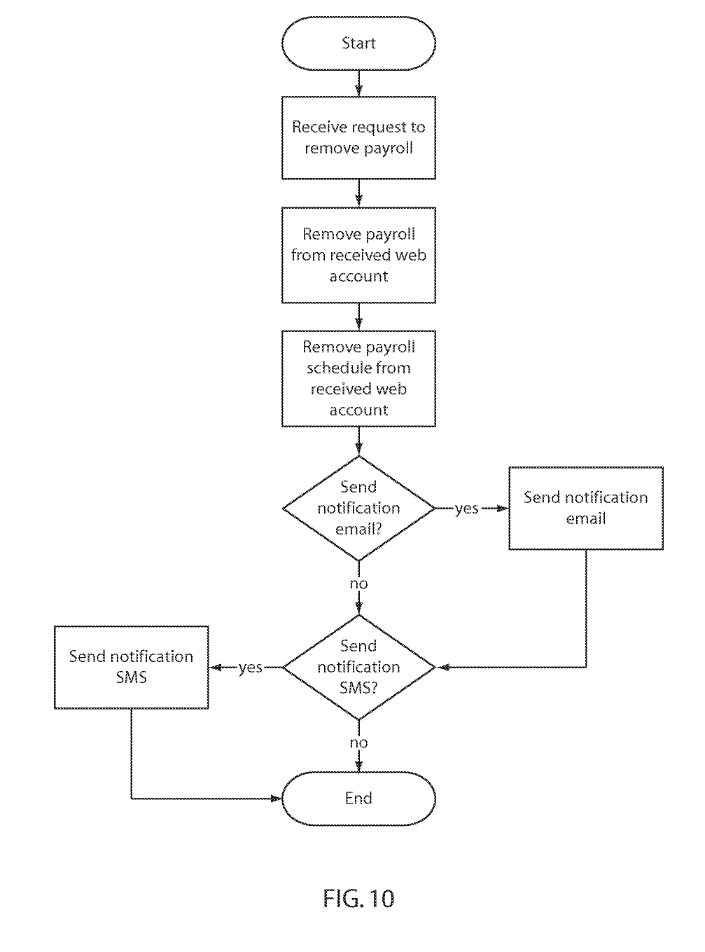

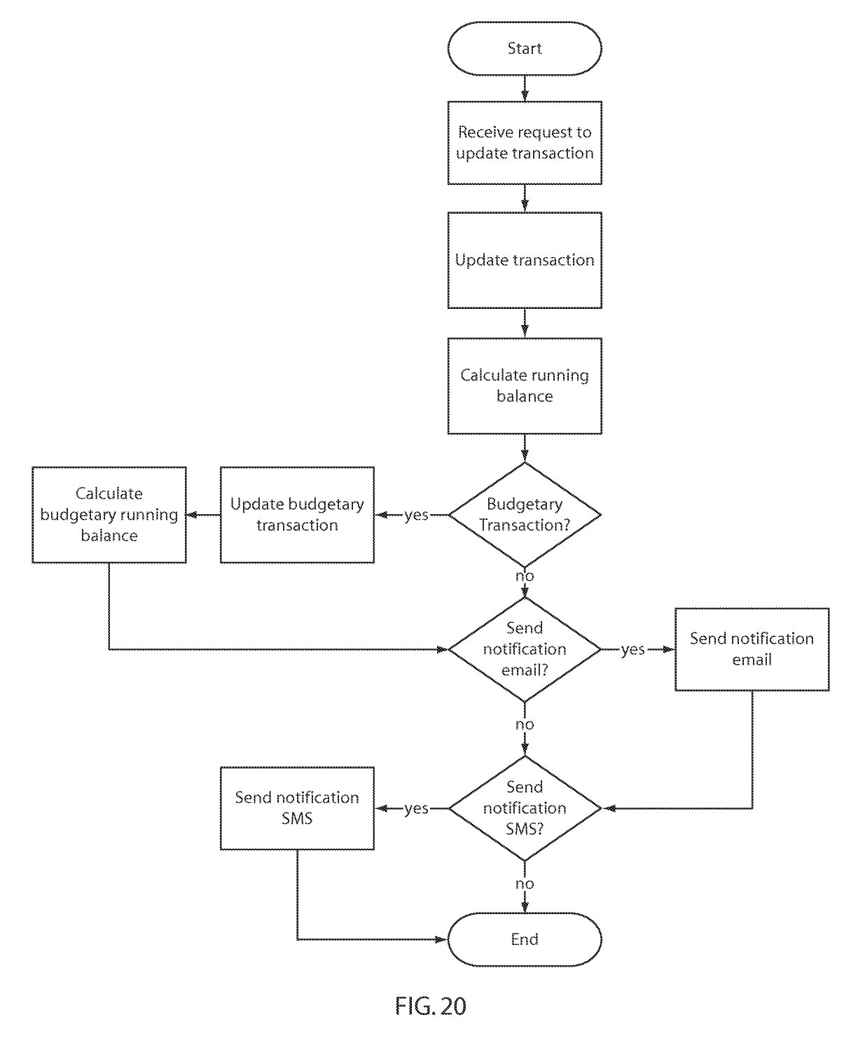

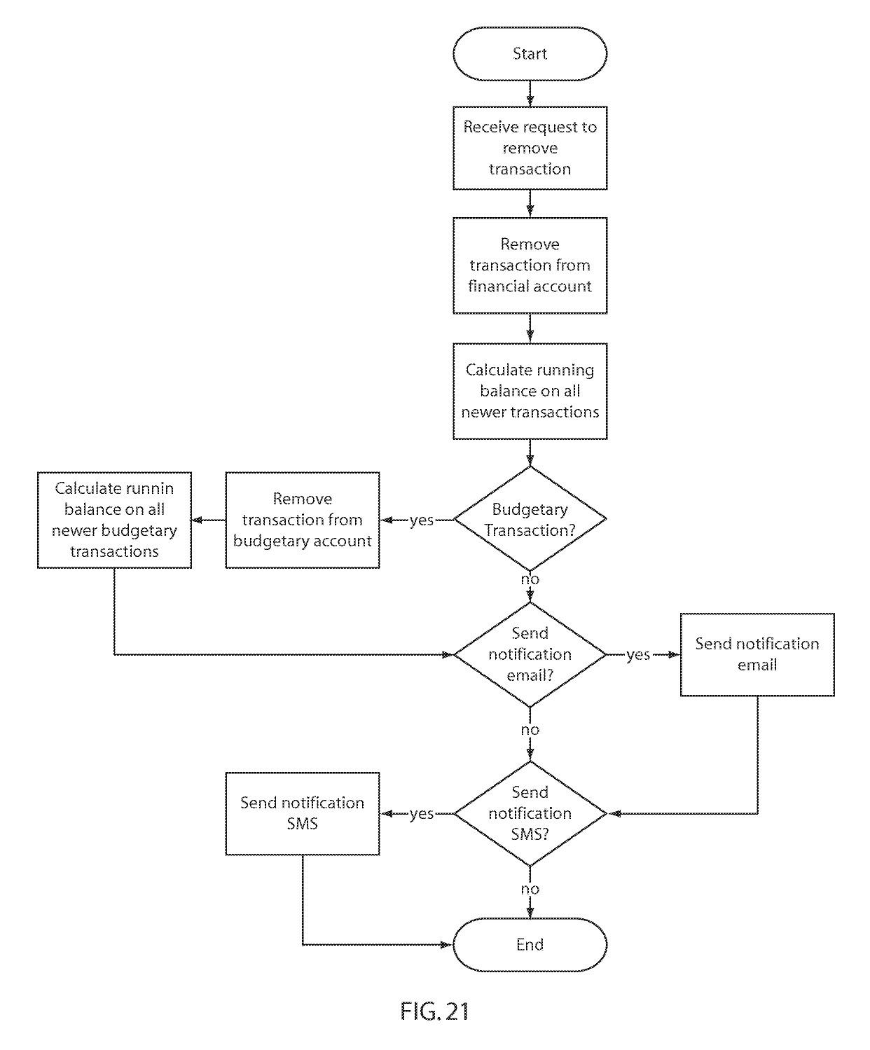

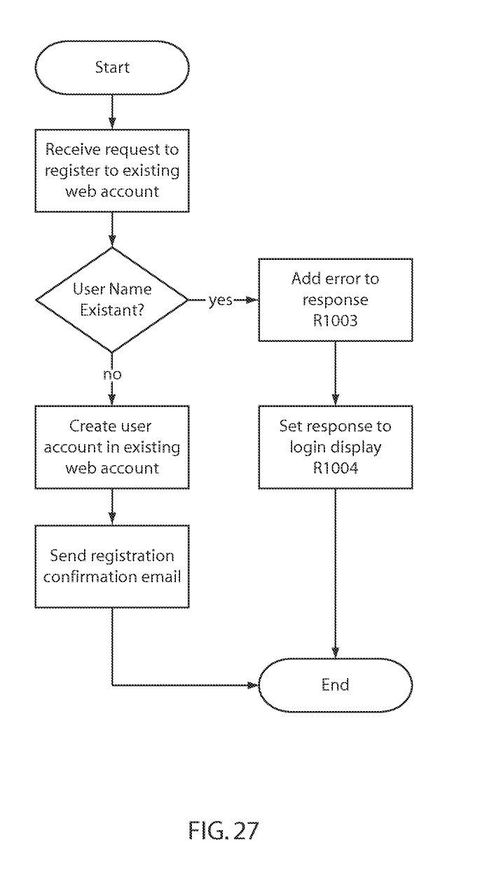

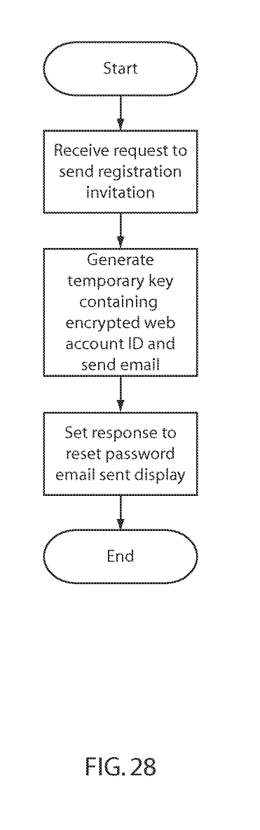

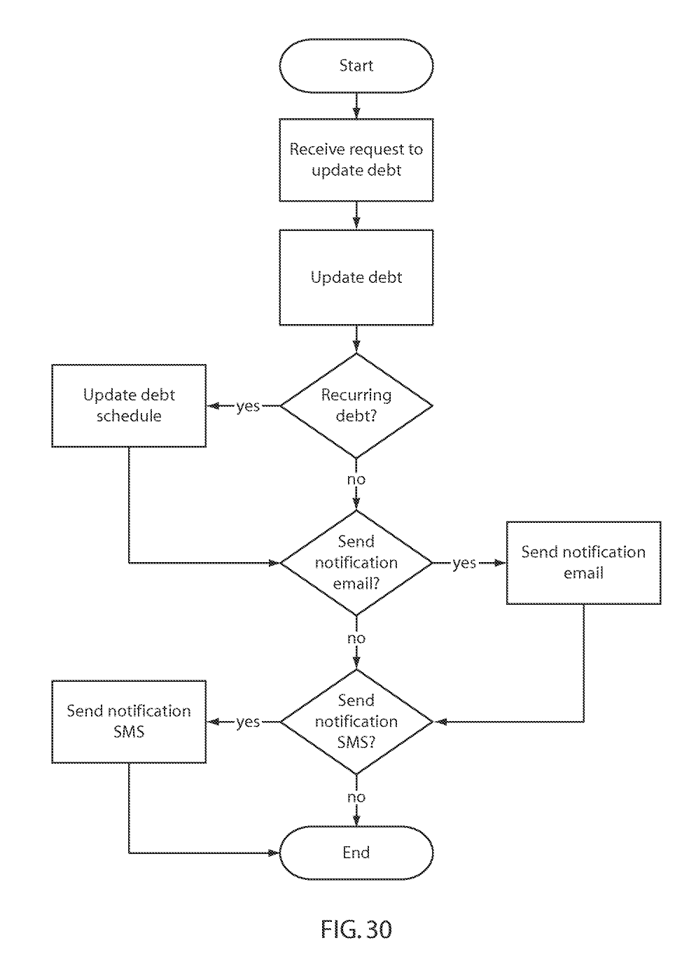

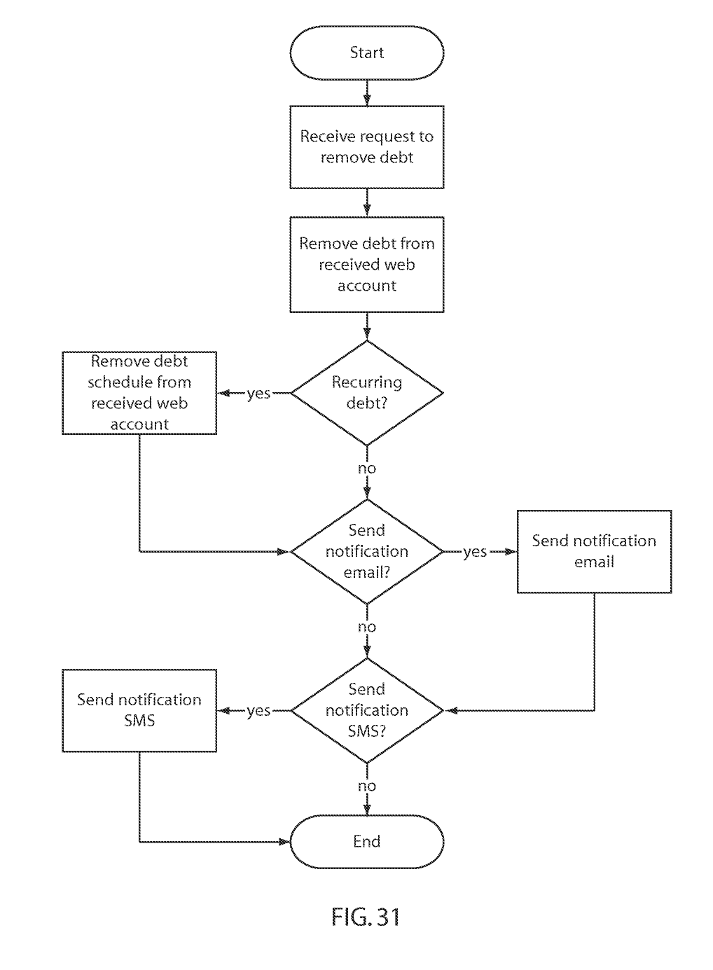

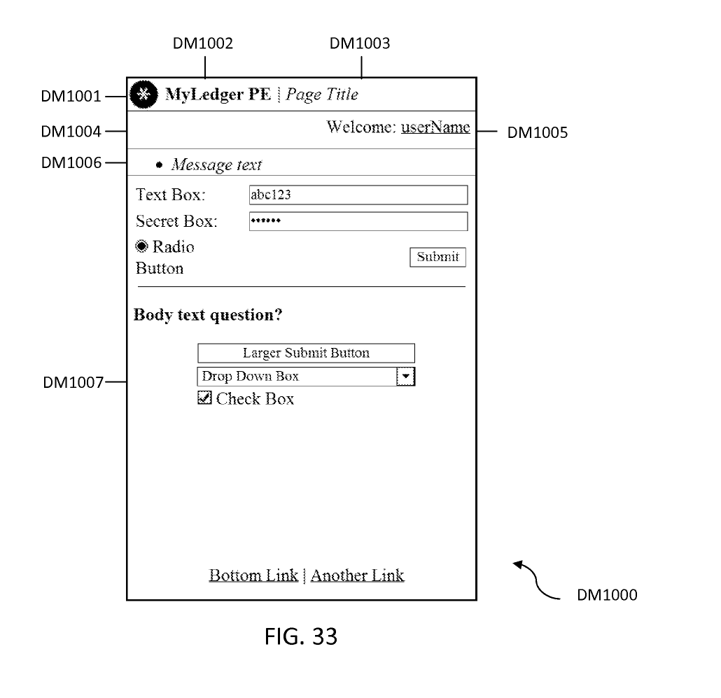

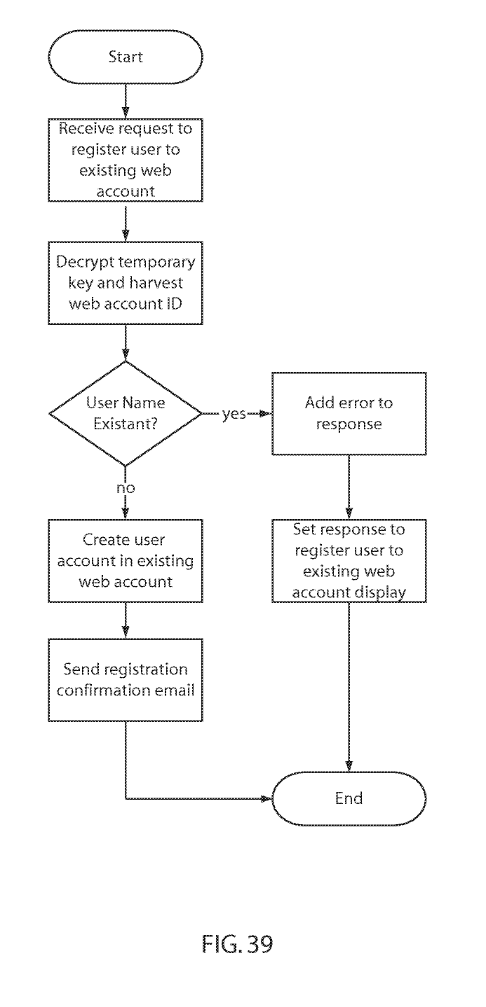

More detailed descriptions for each element in the tool set may be laid out in term of software service functions or even in lines of software codes. However, a presentation of self-explanatory flow diagram and display menu serves to explicitly illustrate the basic functions of each tool. A plurality of flow diagrams of inventive steps (FIG. 1-FIG. 32, and FIG. 39) and typical layout of exemplary display screens (FIG. 33-38) are included below to present the basic framework of this invention. These flow diagrams are self-exemplary for the corresponding tool set and the related steps.

The said web application is built with any programming language, software framework or software server and the said software framework is any set of program libraries or code which is intended for use within another program.

The said server is available to any intranet, internet, GAN, WAN, LAN, or any other computer network and the said web application is for the said mobile devices or the said computers to access the web application and persons or entities may or may not be charged for use of the said web application.

The user account data comprises user id, password, first name, middle name, last name, suffix, prefix, billing address, physical address, birth date, password security question, password security answer and email address;

wherein said user id is a string either given to, or selected by the user, is used to uniquely identify the user by the web application, and represents a user of the web application;
wherein said user of the web application is any person or entity who is to employ the services of the web application;
wherein said password is a string, or a secure hash of a string, either given to, or selected by the user of the web application, and is used to authenticate the user of the web application by the web application or a third party identity management tool, and to authenticate to the web application;
wherein the said first name is a string representing the user of the web application's first name;
wherein the said middle name is a string representing the user of the web application's middle name;
wherein the said last name is a string representing the user of the web application's last name;
wherein said suffix is a suffix of the user of the web application's name such as “Junior”, “Senior” or “Third”;
wherein said prefix is a prefix of the user of the web application's name such as “Doctor”, “Mr.” or “Mrs.”;
wherein said billing address is the billing address of the user of the web application;
wherein said physical address is the physical address of the user of the web application;
wherein said birth date is the birth date of the user of the web application;
wherein said password security question is a string which represents a question which will be presented to the user of the web application to further validate that the user of the web application is who he/she/it says he/she/it is;
wherein said password security answer is a string which represents the answer which is used by the web application to further accurately validate the user of the web application's identity;
wherein said email address is a string which represents the user of the web application's email address.

The web application account data represents individual application accounts and comprises unique id, master user id, activation date, expiry date and account status;

wherein said unique id is a number or string which is used to uniquely identify the individual application accounts;
wherein said master user id is a number or string representation of the user id;
wherein said activation date is the date in which the individual application account became active in the tool;
wherein said expiry date is the date in which the individual application account or became inactive in the tool;
wherein said account status is a numeric or string representation of the status of the account such as “ACTIVE”, “INACTIVE” or “TRIAL”.

The user role data comprises account membership and account user role data;

wherein said account membership data comprises account unique id and user id and is used to associate users of the web application to the individual accounts;
wherein said account unique id is a numeric or string representation of the web application account;
wherein said user id as a string representation of the user id.

The financial data comprises financial account, debt, budget, payroll, and transaction category data;

wherein said financial account data comprises account unique id, account name, financial institution id, financial institution account id, financial institution user name, financial institution password, initial balance, and account type;
wherein said unique id is a string or numeric representation of the individual account and is used by the web application to keep track of the individual account;
wherein said account name is a name given the account by the user;
wherein said financial institution id is a unique id which identifies which financial institution the account resides in, which is to be used by the said web application;
wherein said financial institution account id identifies the specific account within the financial institution;
wherein said financial institution user name is the user name used to access a users financial information provided by the financial institution;
wherein said password is the password used to access a user's financial information provided by the financial institution;
wherein said password is stored as encrypted in the web application using such an algorithm that the password can be decrypted and passed to the financial institution;
wherein said initial balance represents the initial balance of the financial institution account when the web application user account was created;
wherein said account type is a string or numeric value which indicates to the web application what type of financial account the account is (i.e. Primary Checking, Savings etc);
wherein said debt data comprises debts and payment schedule data;
wherein said debts data comprises unique id, description, debt amount, and debt type;
wherein said unique id is a string or a number which is used by the web application to uniquely identify the individual debt record;
wherein said description is a string which is used to describe the individual debt record;
wherein said debt amount is a number which represents the amount of the debt, depending on the debt type;
wherein said debt type is a string or numeric representation of a debt type;
wherein said payment schedule data comprises debt unique id, payment date, payment amount and account unique id;
wherein said debt unique id is the unique id of the debt record;
wherein said payment date month and or day and or year;
wherein said payment amount is the amount of money which is to be paid according to the date;
wherein said account unique id is the unique id of the account from which the payment is to be made;
wherein said budget data comprises unique id, budget name, account unique id, budget type, budget priority, budget schedule, budget amount;
wherein said unique id is a string or numerical value used by the web application to uniquely identify one budget entry;
wherein said budget name is a name given by the user of the web application to identify and describe the defined budget entry;
wherein said account unique id is the unique id for the account;
wherein said budget type is a string or numerical value which is used by the web application to identify the kind of budget being defined;
wherein said budget priority is a numeric value signaling to the web application the priority of the defined budget for use of determining in which order the budgets are to be processed;
wherein said budget schedule is a string or numeric value which is used by the web application to determine when the budget should be processed;
wherein said budget amount is a numeric value representing the static or percentile amount of the account the budget represents;
wherein said payroll data comprises payroll definition and payroll schedule data;
wherein said payroll data comprises unique id, pay source, approximate pay amount, receiving account unique id;
wherein said unique id is a string or number used by the web application to uniquely identify the payroll entry;
wherein said pay source is a string or numeric representation of a pay source to be used by the web application;
wherein said approximate pay amount is a numeric value representing the approximate amount to be deposited into the account;
wherein said account unique id is the unique id;
wherein said data comprises payroll unique id, schedule, and approximate amount;
wherein said unique id is a string or numerical value in which the web application uniquely identifies the individual payroll entries;
wherein said payroll schedule defines how often and when (approximately) payment will be made to the account;
wherein said approximate amount is the approximate amount of money to be deposited into the account according to the payment schedule;
wherein said transaction category data consist of unique id, name and description;
wherein said transaction category unique id is a string or number which uniquely identifies the individual transaction category to the web application;
wherein said transaction category name is the name given to the category to identify the transaction category;
wherein said transaction category description is descriptive text, explaining the purpose of the individual transaction.

The transactional information are transaction records for debts and credits wherein said transaction records contain transaction record id, user account id, financial account id, creating user id, modifying user id, transaction status, transaction date, transaction type, check number, transaction category, transaction description, transaction amount, transaction clearance status and running balance;

wherein said transaction unique id is a string or number which is used by the web application to uniquely identify the individual transaction entries;
wherein said account id is the unique id, uniquely identifying the account in which the transaction is applied to;
wherein said secondary account id is the unique id, uniquely identifying another account that the transaction applies to;
wherein said transaction amount represents the monetary value represented by the individual transaction;
wherein said entry timestamp represents the time that the transaction was entered into the system;
wherein said clearance timestamp represents the time in which the transaction was resolved;
wherein said transaction status represents the status of the transaction in relation to the financial institution's transaction;
wherein said transaction type represents the type of the transaction, such as debit card, credit card, check, ATM or cash withdraw;
wherein said transaction category id is the transaction category, which ties the transaction to a transaction category;
wherein said transaction number is a number to be used by the user of the web application to identify individual transactions;
wherein said entering user id is the user id, identifying the user who entered the transaction into the system;
wherein said modifying user id is the user id, identifying the user who last modified the transaction;
wherein said modified timestamp is the time in which the transaction was last modified;
wherein said description is a string which is used to describe the individual transaction for the user of the web application;
wherein said merchant id is a string or numerical value which represents the second party related to the transaction, such as the store in which a payment was made, or the company from which payment came from;
wherein said running balance is the monetary balance of the account at the time of the transaction.

All user interfaces in this application may be implemented with a template framework ready for internationalization. All user interfaces screens follow the standard display process and all the user interfaces appear on the said mobile devices or computers or SMS or email.

The web application is secure, behind the Secure Sockets Layer (SSL) encryption and hosted on the said server to be accessed by the said mobile devices or computers and the password is a string, or a secure hash of a string, either given to, or selected by the user of the web application, and is used to authenticate the user of the web application.

FIG. 1-3 illustrate the basic steps of the flow diagrams for request to access login, wherein steps of hashing received password and sending credential to third party authentication source from received request are also included.

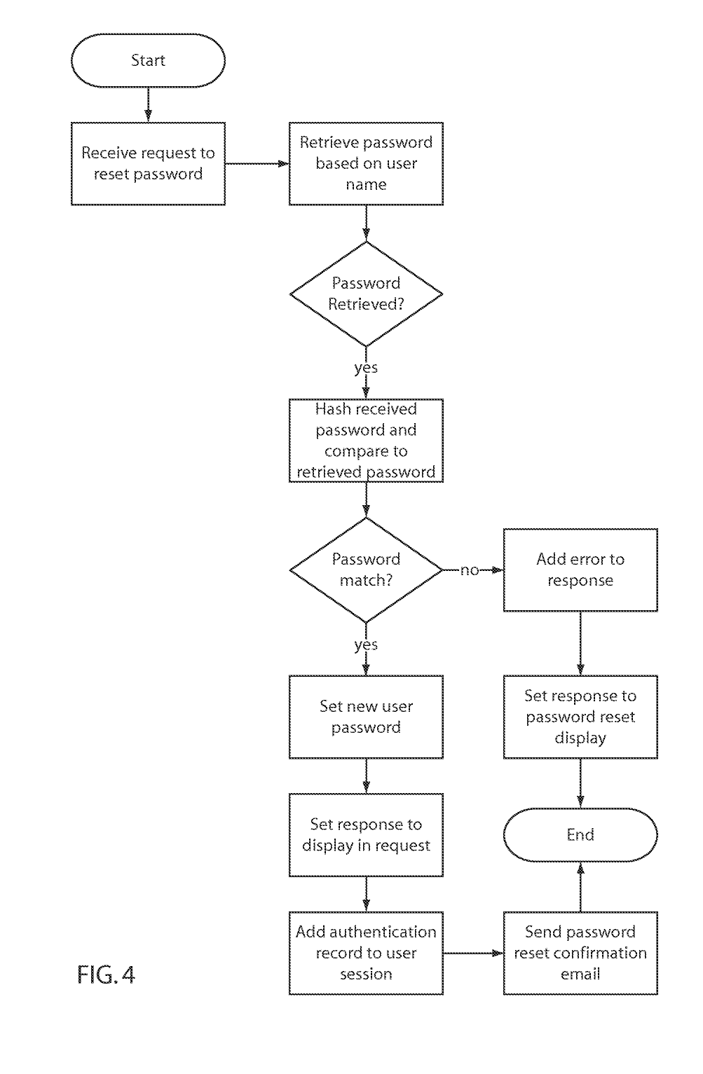

FIG. 4-7 illustrate the basic steps of the flow diagrams for request to access password processing, wherein steps of hashing received password, sending credential to third party authentication source, setting new user password in third party authentication source and add authentication record to user session from received request are also included. Note the integrating features that these services can be implemented by third party applications such as identity and access management software.

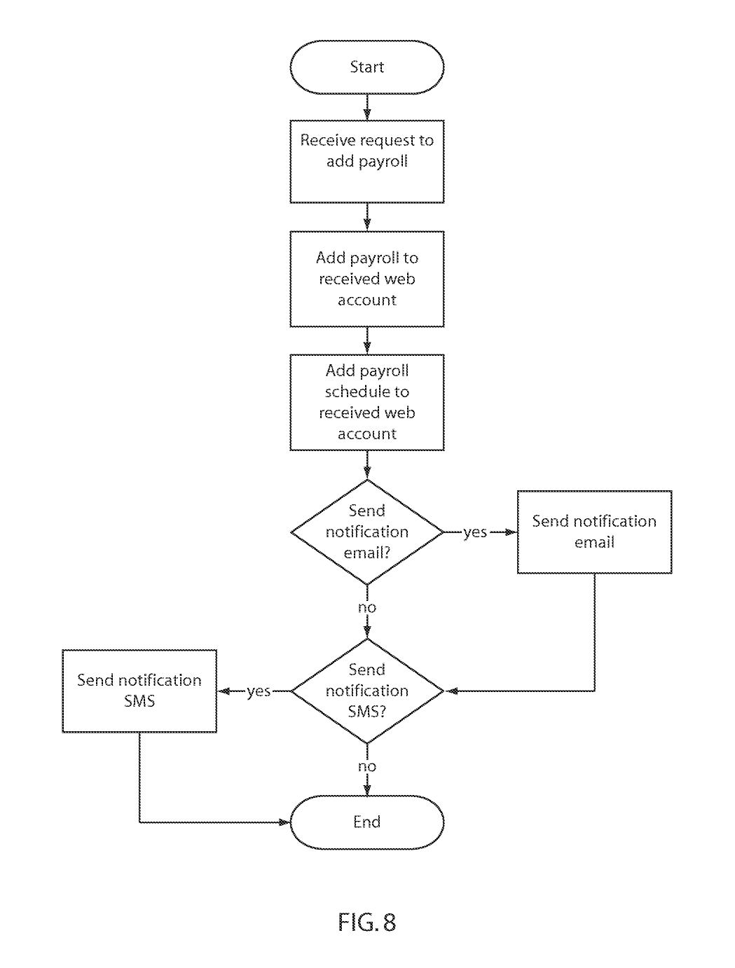

FIG. 8-10 illustrate the basic steps of the flow diagrams for request to access payroll, wherein steps of adding, updating and removing payroll schedule from received request are also included.

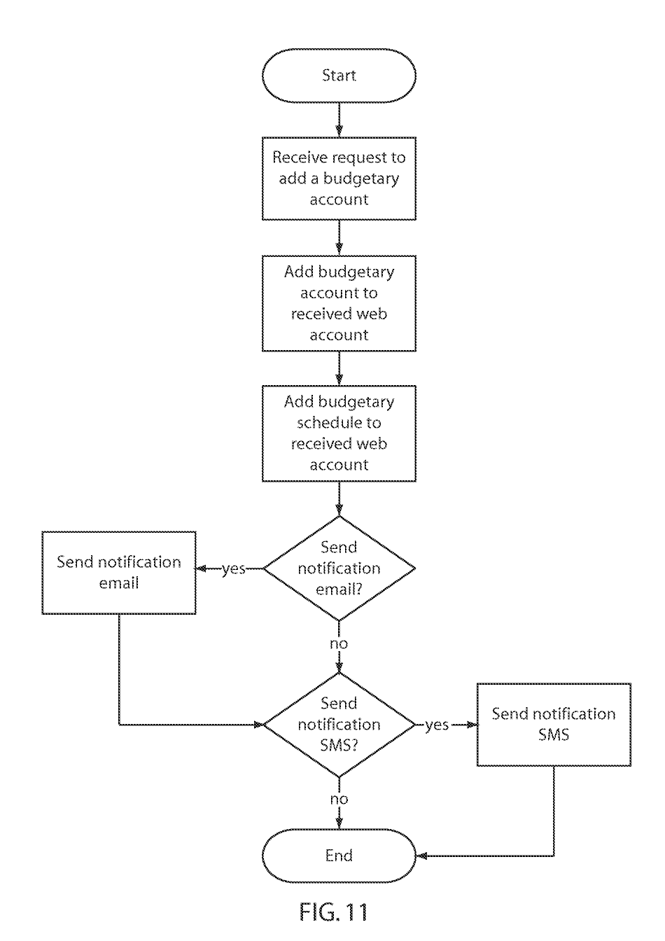

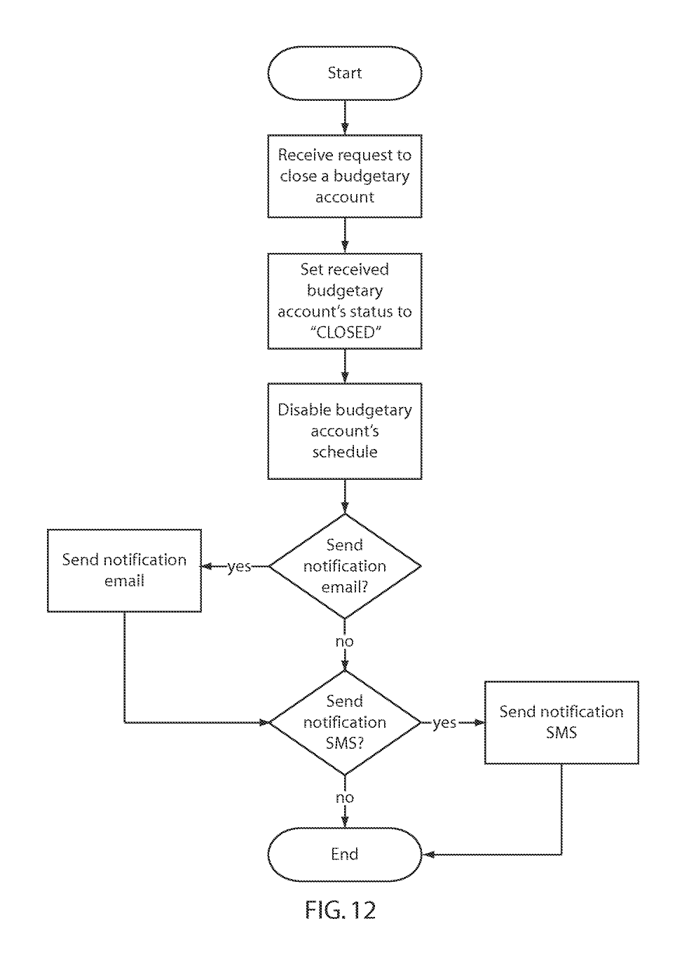

FIG. 11-12 illustrate the basic steps of the flow diagrams for request to access budgetary account, wherein steps of adding and closing budgetary schedule from received request are also included.

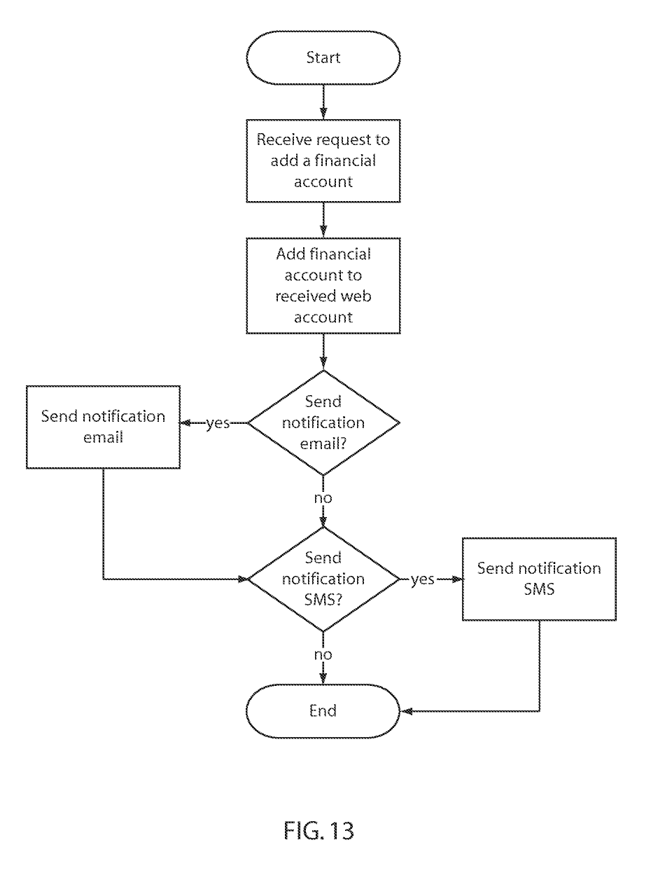

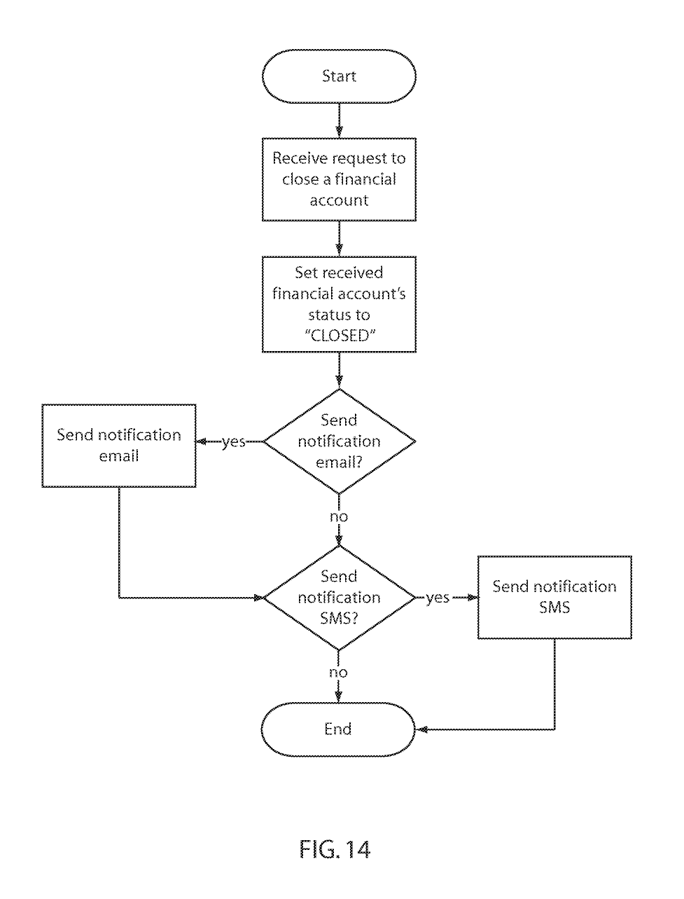

FIG. 13-14 illustrate the basic steps of the flow diagrams for request to access financial account, wherein steps of adding and closing financial account from received request are also included.

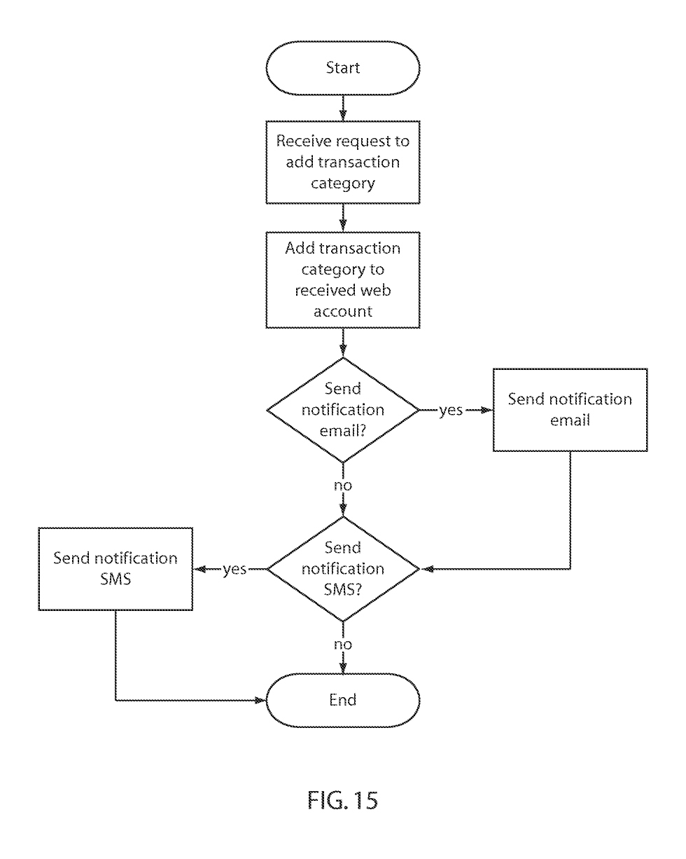

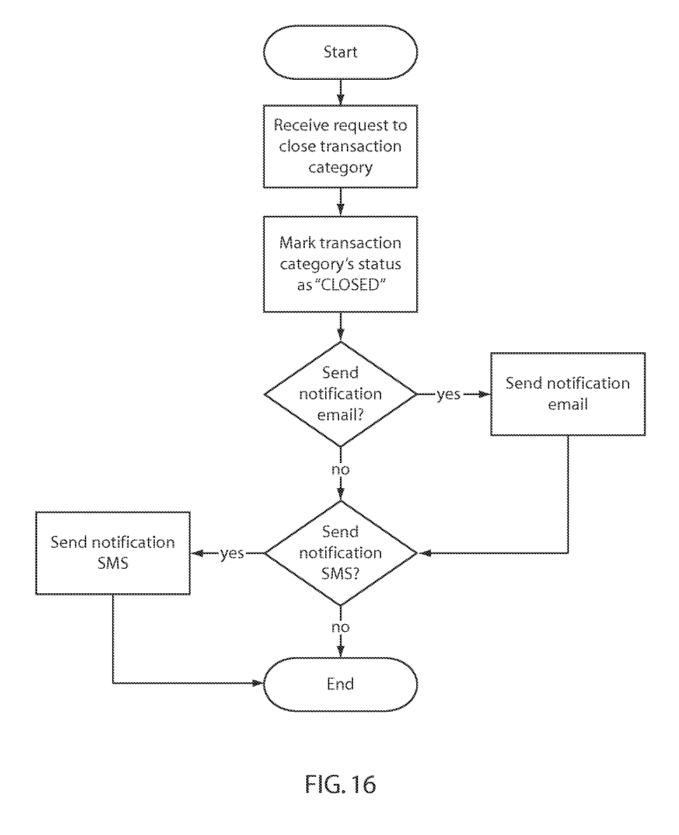

FIG. 15-16 illustrate the basic steps of the flow diagrams for request to access transaction, wherein steps of adding and closing transaction category from received request are also included.

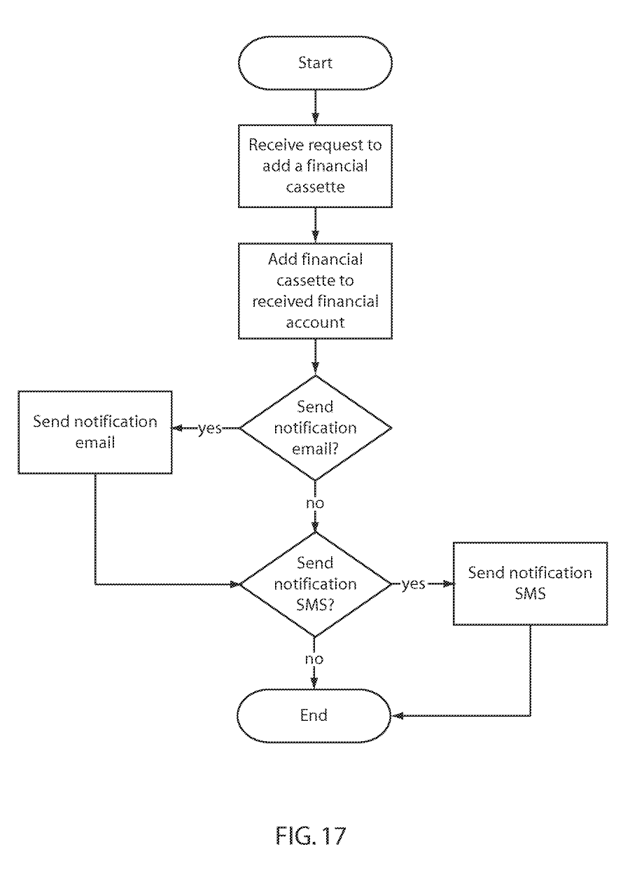

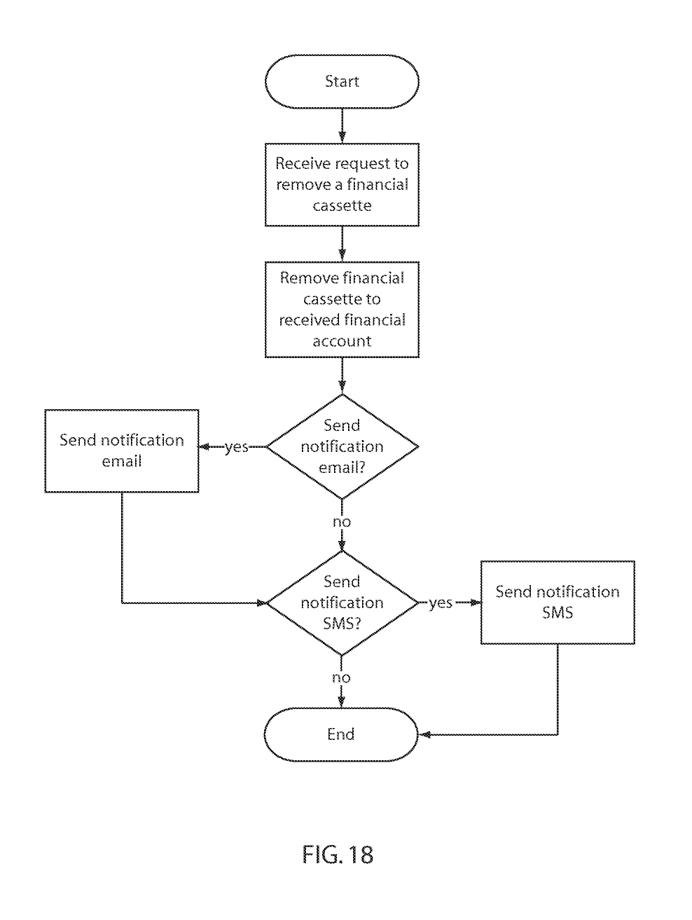

FIG. 17-18 illustrate the basic steps of the flow diagrams for request to access financial cassette, wherein steps of adding and removing financial cassette from received request are also included.

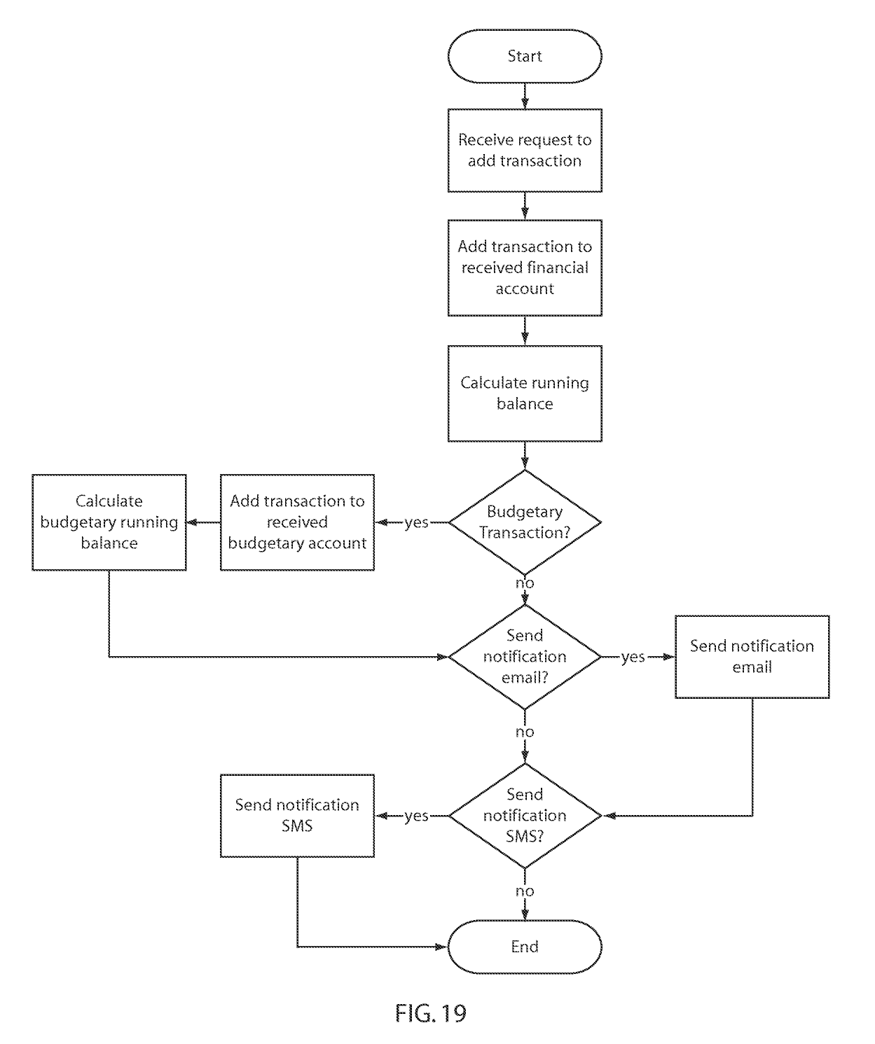

FIG. 19-21 illustrate the basic steps of the flow diagrams for request to access transaction, wherein steps of adding, updating and removing transaction from received request are also included.

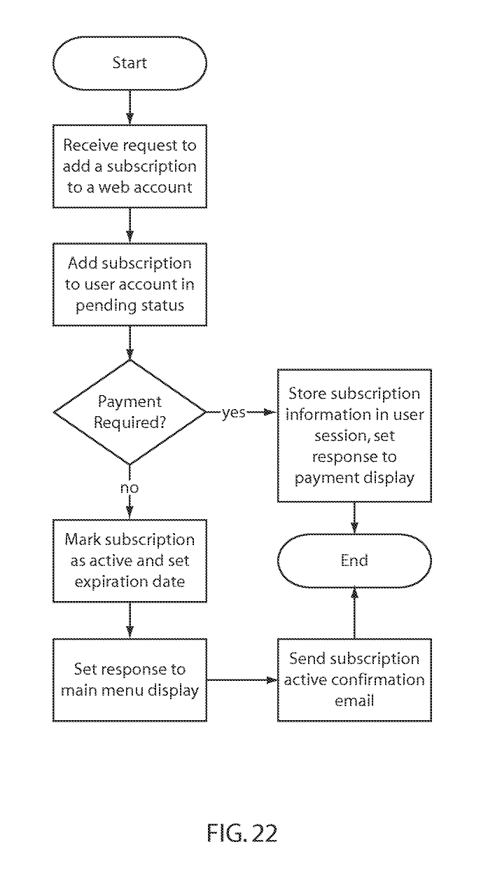

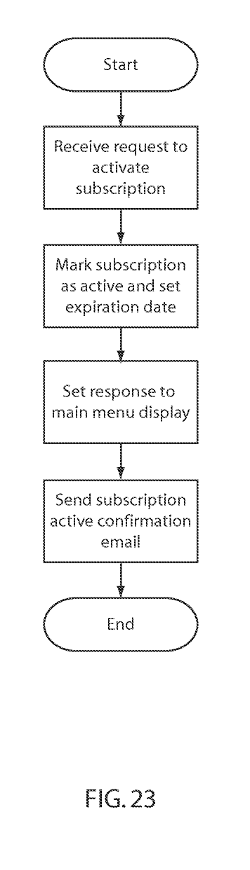

FIG. 22-23 illustrate the basic steps of the flow diagrams for request to access subscription, wherein steps of adding and activating subscription from received request are also included.

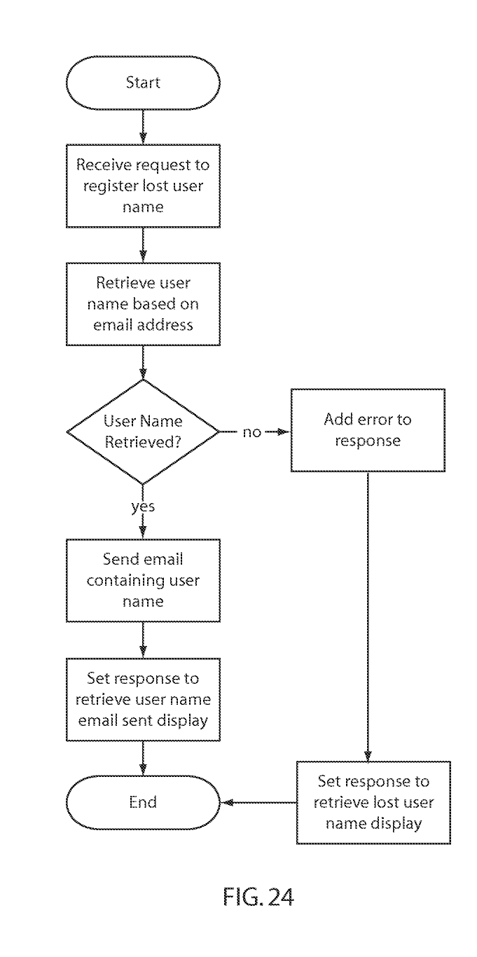

FIG. 24 illustrates the basic steps of the flow diagrams for request to access retrieve lost user name, wherein steps of decision on user name retrieval from received request are also included.

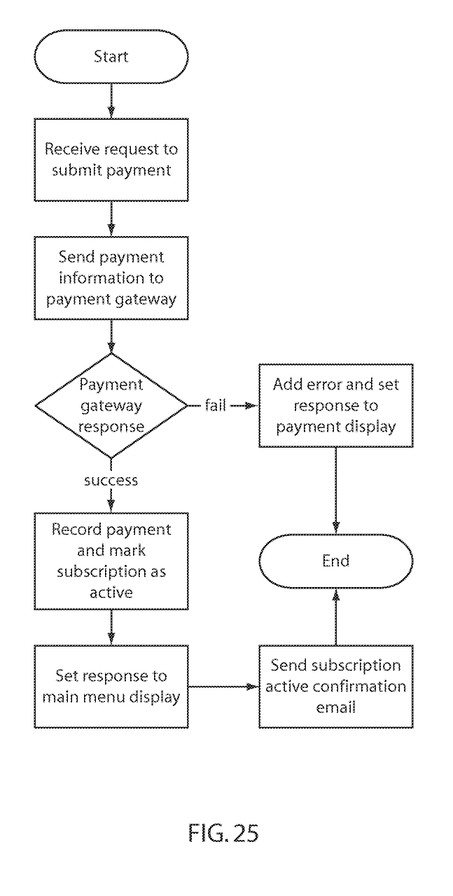

FIG. 25 illustrates the basic steps of the flow diagrams for request to access payment, wherein steps of sending payment information to payment gateway and decision from payment gateway from received request are also included.

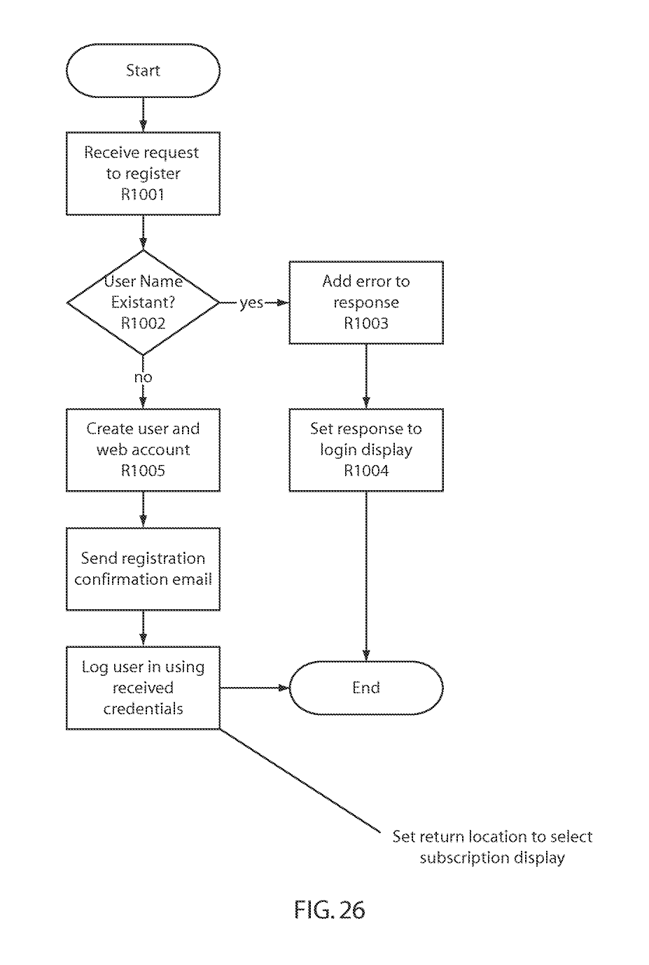

FIG. 26-28 illustrate the basic steps of the flow diagrams for request to access registration, wherein steps of generating temporary key containing encryption web account ID and decrypt temporary key and harvest web account ID from received request are also included.

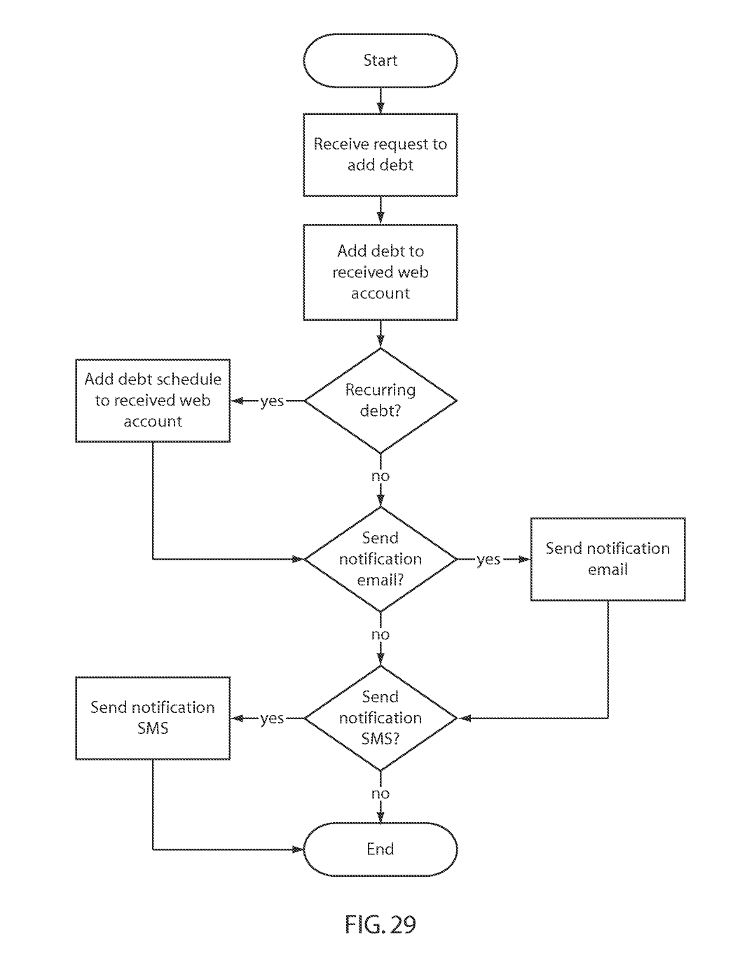

FIG. 29-31 illustrate the basic steps of the flow diagrams for request to access debt, wherein steps of adding, updating and removing debt from received request are also included.

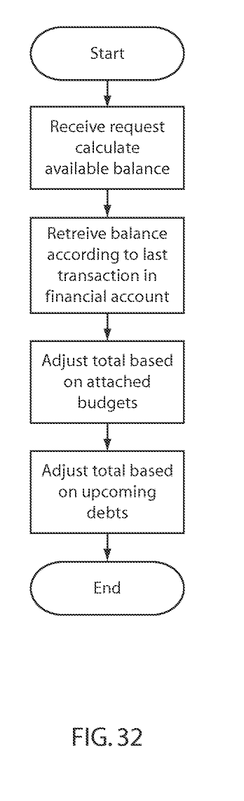

FIG. 32 illustrates the basic steps of the flow diagrams for request to access calculating available balance, wherein steps of adjusting total based budget on attached budget and upcoming debt from received request are also included.

FIG. 33 illustrates a typical screen display for basic ledger, wherein general display components are shown.

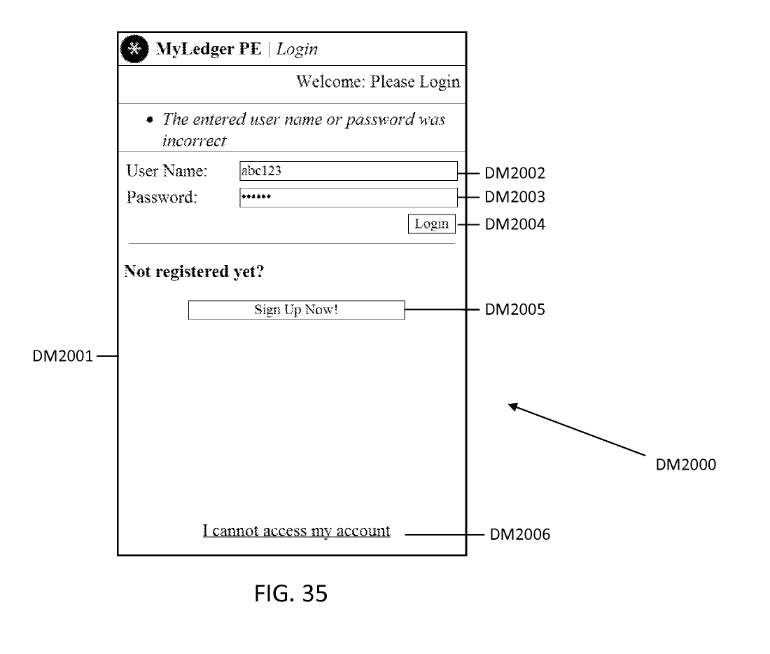

FIG. 35 illustrates a typical screen display for user login, wherein request for user name and password display are shown.

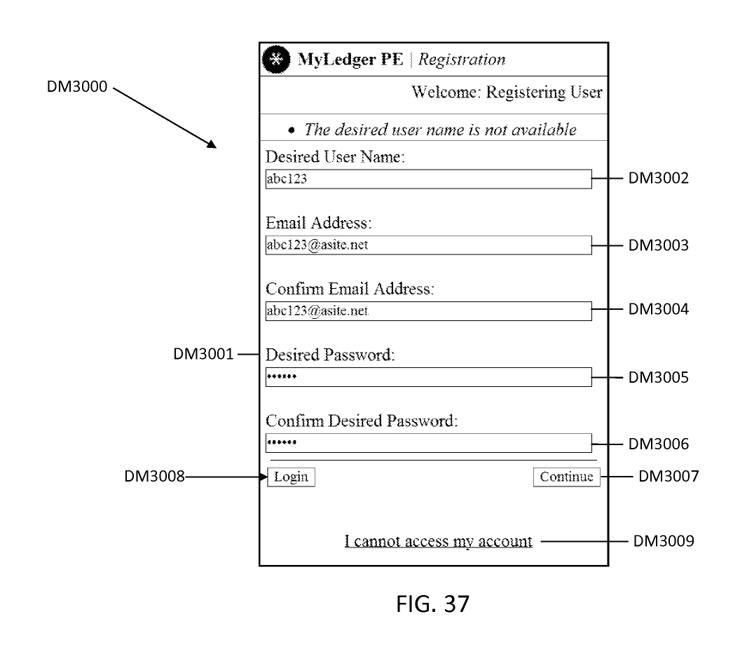

FIG. 37 illustrates a typical screen display for user registration, wherein user registration displays are shown.

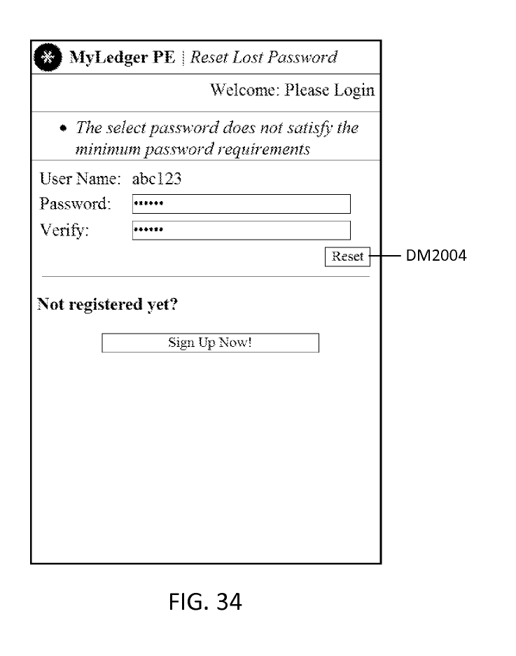

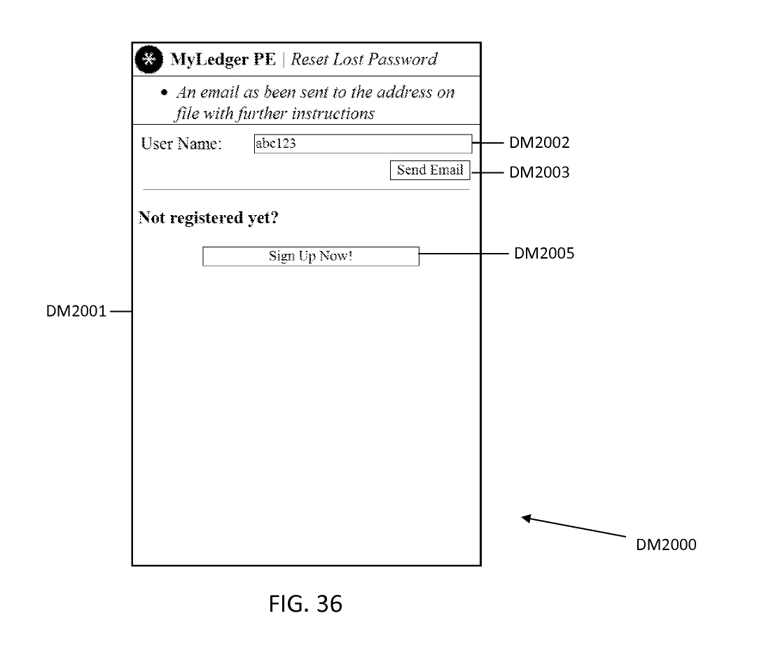

FIGS. 36 and 34 illustrates a typical screen display for user password reset, wherein password reset request, and new password request displays are shown.

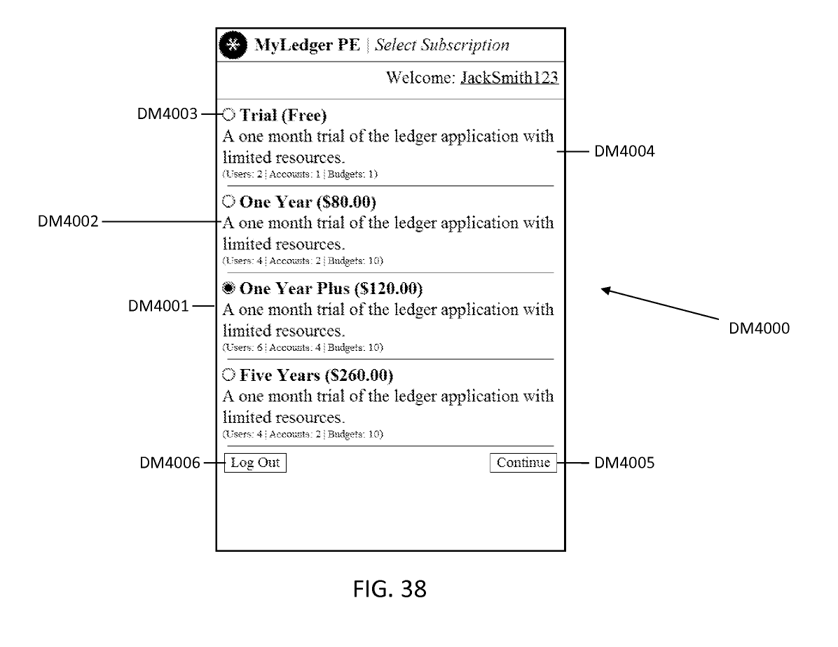

FIG. 38 illustrates a typical screen display for select subscription, wherein budgeting, account and subscription display reset are shown.

Some examples of the diagrams are selected with further details to clarify the relation between the inventive steps and corresponding user interface display screens.

All user interfaces in this application are best implemented with a template framework ready for internationalization. Another concept of templates is known as server side includes. If the application is developed using the Java programming language, such frameworks could be the Apache Software Foundation's Velocity template engine or Tiles. With a framework that provides internationalization, some or all text and images on the page will be loaded from a data source and will display the screen verbiage appropriately depending on the language of the user's client application, such as a web browser or mobile application. The pages are best to be divided up into sections such as header body and footer. The header would contain the application name and logo, and below it, the messages to be displayed to the user. The body will contain the body content of the page, such as the various controls and data. The footer would contain common navigation items. A good solution for this application at the time of this writing is to be developed using the Java EJB 3.1 specification with Java Server Faces as a framework. EJB 3.1 provides the business logic while Java Server Faces provides a strong framework for developing a UI that is internationalization capable and able to change the display depending on the viewing audience. For example, if the site is being viewed on a mobile device, Java Server Faces can be used to display a different UI while still using the same business and/or program logic. Users on a personal computer would get a different UI than users on a mobile device.

All UI screens follow the standard display process unless otherwise stated in the screen's description.

### Samples of User Interfaces

### Display Layout Implementation

FIG. 33 is a diagram illustrating the layout of an exemplary display screen (DM1000) of an internet capable mobile computing device such as a cellular phone. The display screen (DM1000) represents a general layout of the other screens in the web application defined by this document. Generally, the implementation of the display screen (DM1000) illustrated in FIG. 33 includes a title bar (DM1001) along the top of the display. The title bar (DM1001) includes an application title and logo (DM1002) and a page title (DM1003). The application title and logo (DM1002) may be the same throughout all displays as described below and in the display illustrations. The page title (DM1003) may be specific to the display which is currently being displayed.

Below the title bar (DM1001) is a welcome bar (DM1004) that displays a welcome message depending on the authentication status of the current user. Generally, if the user is authenticated to the web application, the user name is displayed as a link (DM1005) which when actuated, logs the user out and redirects them to a display where they may log in. If the user is unauthenticated, a link (DM1005) is displayed which when actuated, redirects the user to a display where they may log in.

Below the welcome bar (DM1004) is a message bar (DM1006) which displays any messages for the user, to the user. These messages may be generated by actions as described below.

Below the message bar (DM1006) is a main screen area (DM1007) that displays, requests and accepts various information depending on the context. In the main menu, the main screen area (DM1007) can contain current financial information. In the main menu, the main screen area (DM1007) can also contain submit buttons to directly access particular features of the web application. The particular display screens described and illustrated herein are described as particular screens that can implement the described tools and techniques. However, various other types of display screen layouts or other types of user interfaces such as audio interfaces could be used.

### Login Screen

FIG. 35 illustrates the login user interface as it might appear on a mobile device. Before the standard UI display process is executed, the user is logged out. Within the main screen area (DM2001) is a set of labeled text boxes. The first of these text boxes (DM2002) requests from the user their user name. The second text box (DM2003) is a password box which hides the typed characters from the screen, masking them with another character such as the asterisk, and requests from the user their password. Below the text boxes is a submit button (DM2004) which submits the form to the Login Process (FIG. 1-FIG. 3), passing the form the contents of the user name and password text boxes. Below the login button is a button (DM2005) which redirects the user to the user registration screen (FIG. 37). At the very bottom of the screen is a link (DM2006) which redirects the user to the reset password screen (FIG. 36).

### Registration Screen

FIG. 37 illustrates the registration interface as it might appear on a mobile device. Before the standard UI display process is executed, the user is logged out.

Within the main screen area (DM3001) is displayed a set of labeled text boxes. The first of these text boxes (DM3002) requests from the user their desired user name. Below the desired user name text box, the email address text box (DM3003) is displayed. Below the email address text box, the confirm email address text box is displayed (DM3004). Below the confirm email address text box, the desired password text box (DM3005) is displayed. The desired password text box (DM3005) is a password text box which masks any typed characters with a single character, such as an asterisk. Below the desired password text box, the confirm desired password text box (DM3006) is displayed. The confirm desired password text box (DM3006) is a password text box which masks any typed characters with a single character, such as an asterisk. Below the labeled text boxes is a pair of submit buttons. The first of these two submit buttons is the login submit button (DM3008) which redirects the user back to the login screen (FIG. 35). The second button is the continue button (DM3007), which submits the form data to the Register Action (FIG. 26). At the very bottom of the screen is a link (DM3009) which redirects the user to the reset password screen (FIG. 36).

### Select Subscription Screen

FIG. 38 illustrates the select subscription interface as it might appear on a mobile device. The select subscription screen requires the user to be authenticated as a master of their Web Account. The user does not need to have an active subscription to access this screen. Within the main screen area (DM4001) is a list of available subscriptions for the user (DM4004). Each subscription item in the list comprises a radio button (DM4003) which the user is to use to select one of the available subscriptions. Next to the radio button for each subscription item, is the title for said item and the price for that subscription item. Below the title and prices for each subscription item is displayed the description (DM4002) for that item. For each subscription item, below the subscription item description (DM4002) is the details of each subscription. Below the list of available subscriptions are two submit buttons. The first button (DM4006) is the logout button and redirects the user back to the login screen (FIG. 35), and as stated above, logs the user out. The second button (DM4005) is the continue button which submits the form data to the select subscription action.

### Samples of Actions

### Register Action

FIG. 26 is a flow diagram illustrating a process for receiving registration information and using said information to create a user and web account. A request is received (R1001). It is determined whether the requested user name exists in the tool already or not. (R1002). If the user name already exists in the tool, an error message is created (R1003) and the user is redirected to the login screen with the error (R1004). The error informs the user that they must choose a user name that does not yet exist in the tool.

If the desired user name is not found in the tool, a process is executed which registers the user into the system (R1005).

### User Interface Example

FIG. 35 illustrates an exemplary display screen (DM2000) purposed as the primary entry display for the web application (referred to herein as the login display screen). The login display screen (DM2000) includes a main screen area (DM2001). The main screen area (DM2001) includes a user name text box (DM2002). The text box (DM2002), as well as similar text boxes discussed below, can accept any text from the user. The user name text box (DM2002) is purposed to accept the user's user name for the web application.

A password text box (DM2003) can accept any text from the user. The password text box (DM2003), masks any text entered with a single character, such as an asterisk. The password text box (DM2003) is purposed to accept the user's password for the web application.

A login submit button (DM2004) can be actuated to indicate that the user is done entering login credentials, and to perform authentication to the web application or third party authentication solution.

A sign up now submit button (DM2005) can be actuated to indicate that the user does not have a web account yet, and to display the register display screen.

An “I cannot access my account” link (DM2006) can be actuated to indicate that the user wants to reset the password for their user account in the web application, and to display the password reset display screen.

Although illustrative embodiments have been described herein with reference to the accompanying drawings is exemplary of a preferred present invention, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A method of financial, account and ledger web application on a system comprising:
a plurality of internet or network capable mobile devices or computers;
a plurality of servers with a database which contains user account, web application account, user role, financial, and transactional data;
a database interface configured to access the database; and
a network interface to access the server,
by executing computer-executable instructions stored on a non-transitory computer-readable medium, and
the method comprises a highly integrated tool set of:
an account transactional ledger tool, comprising the steps of:
initiation by an initial balance during account setup;
automatically working with the automatically recurring payroll; and
billing and budgeting to provide a more accurate available account balance; and
an account balancing tool, comprising the steps of:
balancing user's books;
connecting to banking systems to retrieve a user's financial information;
capable to be trained to automatically clear transactions in the ledger when they are found in the bank's transaction information; and
if it is questionable whether there is a match between a given transaction in the bank and in the ledger, this will be brought to the user's attention in the tool and optionally by email or SMS.

2. A method of financial, account and ledger web application on a system of claim 1,
wherein the said web application is built with any programming language, software framework or software server;
wherein the said software framework is any set of program libraries or code which is intended for use within another program;
wherein the said server is available to any intranet, internet, GAN, WAN, LAN, or any other computer network; and
wherein the said web application is for the said mobile devices or the said computers to receive requests to perform corresponding transactions or the required steps listed in the related or intelligently combined tool sets on the said web servers, and to send responses back to the mobile devices or said computers; and persons or entities may or may not be charged for use of the web application.

3. A method of financial, account and ledger web application on a system of claim 2, further comprising;
a bill management tool, comprising the steps of:
setting up recurring bills and temporary or recurring payment schedules and debts;
automatically generating alerts, via email, text messages and in application notices to remind users to pay individual bills and debts;
creating an estimated recurring payroll into the account for the user; and
integrating with the account ledger functions to provide a more accurate available account balance by creating an entry in the ledger to represent a transaction that is and will be in the financial institution transactions from the ledger to pay automatically recurring bills and temporary payment schedules.

4. A method of financial, account and ledger web application on a system of claim 3, further comprising;
a budgeting tool, comprising the steps of:
providing the ability to create a personal budget based on static amounts or percentages of their income;
creating budgets or budgetary accounts as virtual accounts to better segregate money; and
automatically creating a transaction within the ledger to represent the flow of money from the main account into the virtual account; and
a user management tool, comprising the steps of:
allowing the administrator of the account to create additional users attached to their account; and
providing self help functions for resetting passwords and retrieving lost account information.

5. A method of financial, account and ledger web application on a system of claim 4,
wherein said user account data comprises user id, password, first name, middle name, last name, suffix, prefix, billing address, physical address, birth date, password security question, password security answer and email address;
wherein said web application account data represents individual application accounts and comprises unique id, master user id, activation date, expiry date and account status;
wherein said user role data comprises account membership and account user role data;
wherein said account membership data comprises account unique id and user id and is used to associate users of the web application to the individual accounts;
wherein said financial data comprises financial account, debt, budget and payroll data; and
wherein said transactional information are transaction records for debts and credits wherein said transaction records contain transaction record id, user account id, financial account id, creating user id, modifying user id, transaction status, transaction date, transaction type, check number, transaction category, transaction description, transaction amount, transaction clearance status and running balance.

6. A method of financial, account and ledger web application on a system of claim 5,
wherein all user interfaces in this application may be implemented with a template framework ready for internationalization;
wherein all user interfaces screens follow the standard display process; and
wherein all the user interfaces appear on the said mobile devices or computers or SMS or email.

7. A method of financial, account and ledger web application on a system of claim 6,
wherein the said web application is secure, behind the Secure Sockets Layer (SSL) encryption and hosted on the said server to be accessed by the said mobile devices or computers; and
wherein said password is a string, or a secure hash of a string, either given to, or selected by the user of the web application, and is used to authenticate the user of the web application by and to the web application.

8. A method of financial, account and ledger web application on a system comprising:
a plurality of internet or network capable mobile devices or computers;
a plurality of servers with a database; and
a network interface to access the server,
by executing computer-executable instructions stored on a nontransitory computer-readable medium, and
the method comprises a highly integrated tool set of:
an account transactional ledger tool, comprising the steps of:
initiation by an initial balance during account setup;
automatically working with the automatically recurring payroll; and
billing and budgeting to provide a more accurate available account balance; and
a bill management tool, comprising the steps of:
setting up recurring bills and temporary recurring payment schedules and debts;
automatically generating alerts, via email, text messages and in application notices to remind users to pay individual bills and debts;
creating an estimated recurring payroll into the account for the user; and
integrating with the account ledger functions to provide a more accurate available account balance by creating an entry in the ledger to represent a transaction that is and will be in the financial institution transactions from the ledger to pay automatically recurring bills and temporary payment schedules.

9. A method of financial, account and ledger web application on a system of claim 8, wherein the said web application is built with any programming language, software framework or software server;
wherein the said software framework is any set of program libraries or code which is intended for use within another program;
wherein the said server is available to any intranet, internet, GAN, WAN, LAN, or any other computer network; and
wherein the said web application is for the said mobile devices or the said computers to receive requests to perform corresponding transactions or the required steps listed in the related or intelligently combined tool sets on the said web servers, and to send responses back to the mobile devices or said computers; and persons or entities may or may not be charged for use of the said web application.

10. A method of financial, account and ledger web application on a system of claim 9, further comprising;
an account balancing tool, comprising the steps of:
balancing user's books;
connecting to banking systems to retrieve a user's financial information;
capable to be trained to automatically clear transactions in the ledger when they are found in the bank's transaction information; and
if it is questionable whether there is a match between a given transaction in the bank and in the ledger, this will be brought to the user's attention in the tool and optionally by email or SMS.

11. A method of financial, account and ledger web application on a system of claim 10, further comprising;
a budgeting tool, comprising the steps of:
providing the ability to create a personal budget based on static amounts or percentages of their income;
creating budgets or budgetary accounts as virtual accounts to better segregate money; and
automatically creating a transaction within the ledger to represent the flow of money from the main account into the virtual account; and
a user management tool, comprising the steps of:
allowing the administrator of the account to create additional users attached to their account; and
providing self help functions for resetting passwords and retrieving lost account information.

12. A method of financial, account and ledger web application on a system of claim 11,
wherein said user account data comprises user id, password, first name, middle name, last name, suffix, prefix, billing address, physical address, birth date, password security question, password security answer and email address;
wherein said web application account data represents individual application accounts and comprises unique id, master user id, activation date, expiry date and account status;
wherein said user role data comprises account membership and account user role data;
wherein said account membership data comprises account unique id and user id and is used to associate users of the web application to the individual accounts;
wherein said financial data comprises financial account, debt, budget and payroll data; and
wherein said transactional information are transaction records for debts and credits wherein said transaction records contain transaction record id, user account id, financial account id, creating user id, modifying user id, transaction status, transaction date, transaction type, check number, transaction category, transaction description, transaction amount, transaction clearance status and running balance.

13. A method of financial, account and ledger web application on a system of claim 12,
wherein all user interfaces in this application may be implemented with a template framework ready for internationalization;
wherein all user interfaces screens follow the standard display process; and
wherein all the user interfaces appear on the said mobile devices or computers or SMS or email.

14. A method of financial, account and ledger web application on a system of claim 13,
wherein the said web application is secure, behind the Secure Sockets Layer (SSL) encryption and hosted on the said server to be accessed by the said mobile devices or computers and
wherein said password is a string, or a secure hash of a string, either given to, or selected by the user of the web application, and is used to authenticate the user of the web application.

15. A method of financial, account and ledger web application on a system comprising:
a plurality of internet or network capable mobile devices or computers;
a plurality of servers with a database; and
a network interface to access the server,
by executing computer-executable instructions stored on a nontransitory computer-readable medium, and
the method comprises a highly integrated tool set of:
an account transactional ledger tool, comprising the steps of:
initiation by an initial balance during account setup;
automatically working with the automatically recurring payroll; and
billing and budgeting to provide a more accurate available account balance;
a budgeting tool, comprising the steps of:
providing the ability to create a personal budget based on static amounts or percentages of their income;
creating budgets or budgetary accounts as virtual accounts to better segregate money; and
automatically creating a transaction within the ledger to represent the flow of money from the main account into the virtual account; and
a user management tool, comprising the steps of:
allowing the administrator of the account to create additional users attached to their account; and
providing self help functions for resetting passwords and retrieving lost account information.

16. A method of financial, account and ledger web application on a system of claim 15, herein the said web application is built with any programming language, software framework or software server;
wherein the said software framework is any set of program libraries or code which is intended for use within another program;
wherein the said server is available to any intranet, internet, GAN, WAN, LAN, or any other computer network; and
wherein the said web application is for the said mobile devices or the said computers to receive requests to perform corresponding transactions or the required steps listed in the related or intelligently combined tool sets on the said web servers, and to send responses back to the mobile devices or said computers; and persons or entities may or may not be charged for use of the web application.

17. A method of financial, account and ledger web application on a system of claim 16, further comprising;
a bill management tool, comprising the steps of:
setting up recurring bills and temporary or recurring payment schedules and debts;
automatically generating alerts, via email, text messages and in application notices to remind users to pay individual bills and debts;
creating an estimated recurring payroll into the account for the user; and
integrating with the account ledger functions to provide a more accurate available account balance by creating an entry in the ledger to represent a transaction that is and will be in the financial institution transactions from the ledger to pay automatically recurring bills and temporary payment schedules.

18. A method of financial, account and ledger web application on a system of claim 17, further comprising;
an account balancing tool, comprising the steps of:
balancing user's books;
connecting to banking systems to retrieve a user's financial information;
capable to be trained to automatically clear transactions in the ledger when they are found in the bank's transaction information; and
if it is questionable whether there is a match between a given transaction in the bank and in the ledger, this will be brought to the user's attention in the tool and optionally by email or SMS.

19. A method of financial, account and ledger web application on a system of claim 18,
wherein said user account data comprises user id, password, first name, middle name, last name, suffix, prefix, billing address, physical address, birth date, password security question, password security answer and email address;
wherein said web application account data represents individual application accounts and comprises unique id, master user id, activation date, expiry date and account status;
wherein said user role data comprises account membership and account user role data;
wherein said account membership data comprises account unique id and user id and is used to associate users of the web application to the individual accounts;
wherein said financial data comprises financial account, debt, budget and payroll data; and
wherein said transactional information are transaction records for debts and credits wherein said transaction records contain transaction record id, user account id, financial account id, creating user id, modifying user id, transaction status, transaction date, transaction type, check number, transaction category, transaction description, transaction amount, transaction clearance status and running balance.

20. A method of financial, account and ledger web application on a system of claim 19,
wherein all user interfaces in this application may be implemented with a template framework ready for internationalization;
wherein all user interfaces screens follow the standard display process; and
wherein all the user interfaces appear on the said mobile devices or computers or SMS or email.
wherein the said web application is secure, behind the Secure Sockets Layer (SSL) encryption and hosted on the said server to be accessed by the said mobile devices or computers and
wherein said password is a string, or a secure hash of a string, either given to, or selected by the user of the web application, and is used to authenticate the user of the web application.
